(19) United States
(12) Patent Application Publication
(10) Pub. No.: US 2016/0321587 A1
(43) Pub. Date: Nov. 3, 2016

(54) PROJECT ANALYSIS, DATA DRIVEN RECOMMENDATIONS, ALERT GENERATION AND PROJECT USER INTERFACE GENERATION SYSTEM

(71) Applicant: BKI SOFTWARE SOLUTIONS, Oakland, CA (US)

(72) Inventors: Brian Keith Gitt, San Francisco, CA (US); Rebecca Catherine Brown, Oakland, CA (US)

(21) Appl. No.: 15/143,392

(22) Filed: Apr. 29, 2016

Related U.S. Application Data
(60) Provisional application No. 62/156,155, filed on May 1, 2015.

(51) Int. Cl. G06Q 10/06; G06Q 50/16

(52) U.S. Cl. CPC G06Q 10/06313; G06Q 50/163

(57) ABSTRACT

Methods, systems, and apparatus, including computer programs encoded on computer storage media, for determining property improvement projects. One of the methods includes obtaining information identifying an area, and information describing one or more properties associated with the area. One or more utility use estimates are determined for products associated with a plurality of property improvement projects. One or more property improvement projects are determined based on the utility use estimates. The one or more property improvement projects are provided for presentation.

### CROSS-REFERENCE TO RELATED APPLICATIONS

Any and all applications for which a foreign or domestic priority claim is identified in the Application Data Sheet as filed with the present application are hereby incorporated by reference in their entirety under 37 CFR 1.57.

### BACKGROUND

Property improvement projects can affect operation costs of owning a home or building. Operation costs related to utilities, e.g., electricity, water, can be a significant cost to owning and maintaining a property. Property owners are most likely to implement energy and water efficiency improvements when encountering various trigger events.

For instance, a first trigger can include utility bill rate increases. Property owners that experience significant increases on their energy and or water bills are likely receptive to property improvements that will decrease their utility bills.

A second trigger can be associated with property improvements and/or remodeling. Property owners that are already planning on undergoing an upgrade to their home, building, or landscape are more receptive to incorporating energy and water efficiency into the improvement project.

A third trigger can be associated with major system/appliance performance issues. If a major system or appliance (e.g. heating, cooling, water heating, clothes washer, etc.) is no longer performing up to expectations or is past its useful life, property owners are likely to consider energy and water efficiency in their purchase decision.

A fourth trigger can include a home or building purchase. New property owners are likely to be making improvements within the first few months of purchasing a new property, and are thus more receptive to incorporating utility efficiency improvements.

A need exists for a system to provide property owners and project managers pertinent information on operation costs associated with various project improvement choices.

### SUMMARY

This specification describes a new and innovative system and application that help property owners find the most efficient, and most informed, ways to save on utility usage and costs. The system can quickly identify improvement projects, e.g., an appliance upgrade, that a user can implement to reduce utility costs and/or utility usage. Properties can include commercial properties, residential properties, e.g., homes, multi-unit dwellings, municipal properties, and so on.

The system can quickly identify property improvement projects and analyze expected benefits to consumers, e.g., lower utility costs, along with analyzing rebates from utility companies or governmental organizations. The benefits can be specific to the utility companies servicing the particular property and/or municipal level location. Operational cost information for various choices can be presented for more refined and accurate cost information, both location-specific (e.g., accounting for utility costs for a municipality or address) and project-choice specific (e.g., for particular product models). The system can determine estimated labor costs (e.g., the system can monitor actual costs of property improvement projects, and determine a measure of central tendency of each property improvement project), or the system can obtain actual labor costs as specified by contractors (e.g., contractors located in a same geographic region as the consumers). To provide realistic costs associated with implementing a property improvement project, the system can determine availability of financing, and compare and contrast different methods of financing (e.g., property-assessed clean energy programs, bank loans, online lenders, and so on).

Consumers can implement the property improvement projects using products recommended by the system, and/or with professionals, e.g., contractors, to perform the physical implementation. Using the system, professionals, e.g., contractors, realtors, can gain an understanding of specific property improvement projects that can be implemented for specific houses, or other properties, and the system can automatically generate reports and analyses, e.g., obtain a list of addresses of potential customers. In this way, professionals can better reach out to an audience determined, by the system, to benefit from their services.

In addition, the system can quantify an expected increase in a property's value that can be attributed to a particular implemented property improvement project. For instance, the system can monitor property sales and features associated with each property. The system can, for instance, utilize one or more machine learning algorithms (e.g., k-means clustering) to determine an expected increase in a property's value given an implemented property improvement project.

The details of one or more embodiments of the subject matter of this specification are set forth in the accompanying drawings and the further description below. Other features, aspects, and advantages of the subject matter will become apparent from the description, the drawings, and the claims.

### BRIEF DESCRIPTION OF THE DRAWINGS

FIG. 1 illustrates a flowchart of an example process for property project analysis and data driven recommendations.

FIG. 2 illustrates a block diagram of an example property improvement system.

FIG. 3 is a flowchart of an example process for providing property improvement projects.

FIG. 4 is a flowchart of an example process for modifying property improvement projects based on user refinement information.

FIG. 5A is a flowchart of an example process for determining baseline utility usage estimates associated with a property.

FIG. 5B illustrates an example process for determining utility use reduction estimates and utility cost reduction estimates associated with property improvement projects.

FIG. 6 is a flowchart of an example process for generating documents identifying property improvement projects associated with a professional.

FIG. 7 is a flowchart of an example process for providing information to a retailer identifying rebates, or property improvement projects, associated with products they sell.

FIGS. 8A-8O illustrate example user interfaces.

FIG. 8P illustrates an example user interface for presenting summary information associated with property improvement projects.

Like reference numbers and designations in the various drawings indicate like elements.

### DETAILED DESCRIPTION

### Introduction

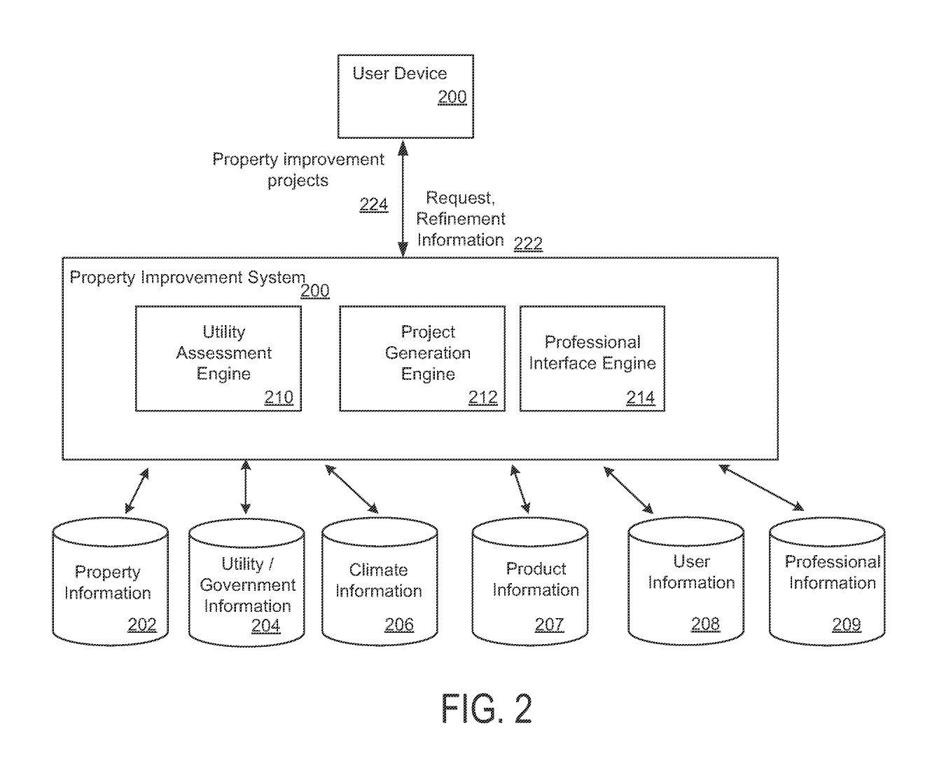

A system described in this specification, e.g., the property improvement system 200 described in FIG. 2, can quickly, and without much user interaction, provide information describing improvement projects for a user's property (e.g., upgrading a user's kitchen or bathroom). Each property improvement project is determined to provide a reduction in the user's utility usage, e.g., water, gas, electric, sewer, and/or a reduction in the user's utility costs. The system can provide beneficial information to the user to implement each project, for instance, the system can provide recommended products and systems that the user can purchase for each project, and recommend professionals that can perform the work required for each project. Products and systems can include anything that is within the bounds of a property, such as appliances and fixtures, and can include landscape materials (e.g., grass, plants), toilets, lawns, pools, dish washers, washing machines, showerheads, furnaces, stoves, refrigerators, faucets, and so on.

Additionally, the system can quickly provide return on investment information for each project, such as by determining an expected increase in a property's value once the project is implemented, and associated government, or utility company based, rebate information relevant to the property's location. Rebate information can include tax savings, utility cost credits applied to utility bills, and so on. Similarly, the system can quantify reductions in utility usage after implementation of a property improvement project, and using actual utility rates for an area, can quantify an expected monetary savings.

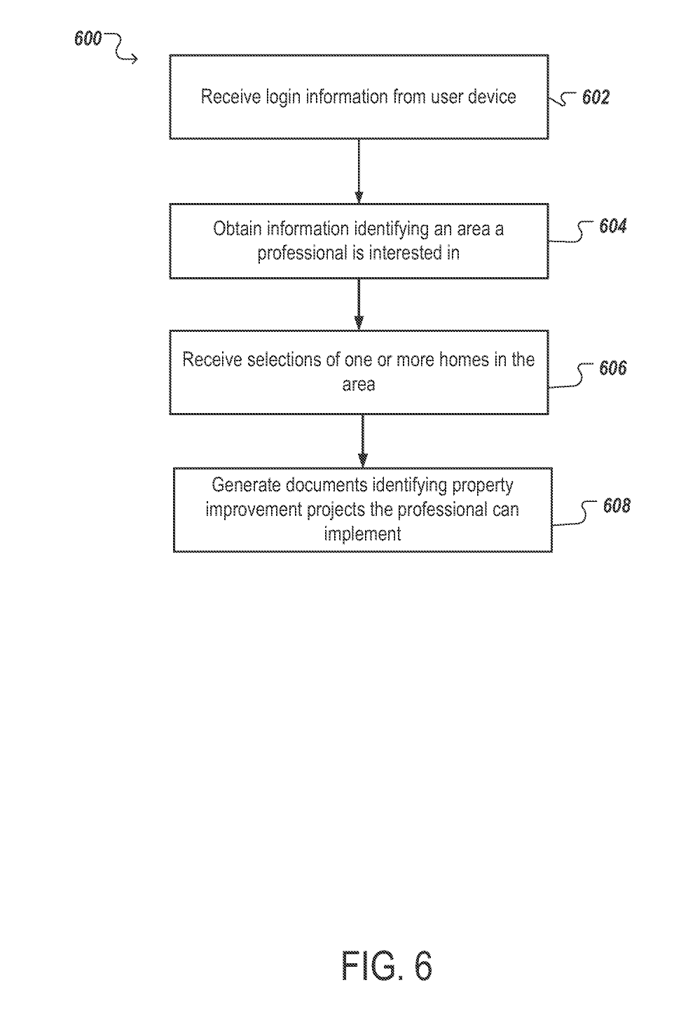

The system can also be utilized by professionals to help canvass for leads, e.g., a professional landscaper can identify properties that would benefit from modifying the landscape from grass to native or drought tolerant plantings. The system can generate documents to mail, or otherwise provide, to potential customers that appear to be from specific professionals. The generated documents can identify improvement projects that a particular professional can implement, and potential costs of implementation. Generating documents for professionals is described below, with reference to FIG. 6.

Similarly, the system can increase a likelihood that a professional (e.g., a contractor, a professional landscaper as described above, and so on) will make a sale to a property owner. For instance, a professional can provide an indication of a total cost of the professional implementing a particular property improvement project, for instance the cost of labor, materials, and so on. The system can then present (e.g., to the property owner), information specifying the professional's cost, along with benefits to the property owner upon implementation of the property improvement project (e.g., reduction in utility usage, increase in home value, tax breaks, rebates, and so on). In this way, the property owner can easily view the positive information of implementing a project, increasing a likelihood of the property owner implementing the project.

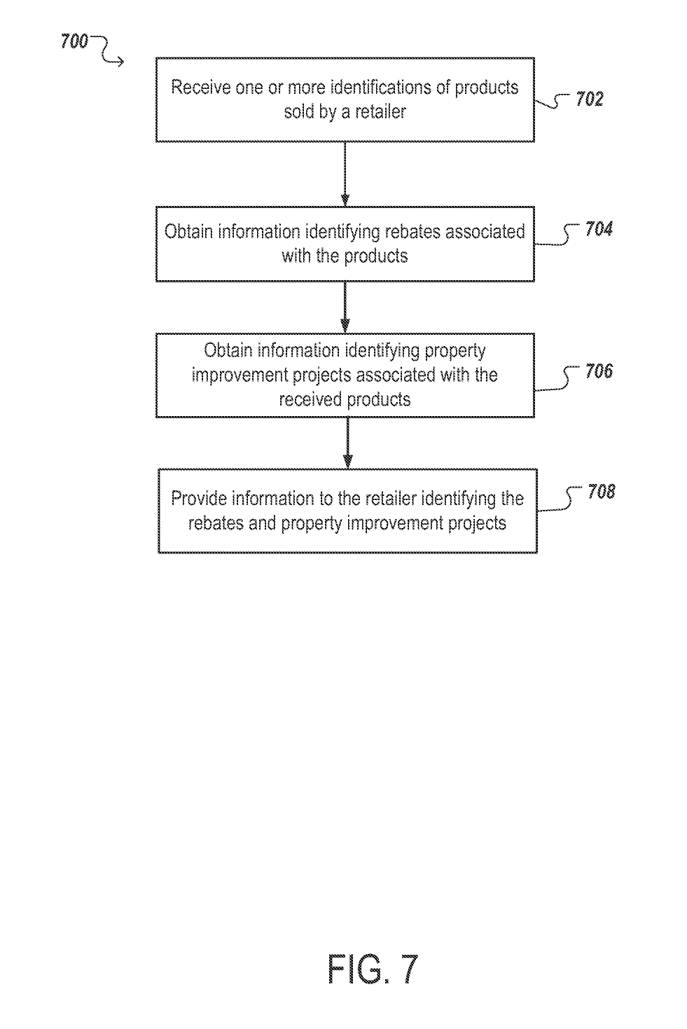

Retailers can utilize the system to identify utility bill savings, rebates, and purchase financing options associated with products they carry (e.g., sell to consumers), and/or average reductions in utility usage if the products are utilized. To increase sales, this information can be provided to users as they are shopping at the retailers. Additionally potential improvement projects can be generated that utilize products a retailer carries. The retailer can provide information identifying the improvement projects as incentives for customers to purchase specific products. An example method of a retailer using the system is described below, with reference to FIG. 7.

The system can provide important information as an immediate notification for presentation to a user, for instance on an application executing on the user's user device that is associated with the system. As an example, the system can monitor rebate information, and based on the user having previously viewing information associated with a property improvement project, can trigger a notification to the user specifying that rebates are temporarily available for the project. Additionally, the system can access weather prediction information, and if upcoming months are going to be especially hot (e.g., a threshold variance above a mean), the system can trigger a notification to the user that includes utility savings associated with upgrading an air conditioning unit. In this way, the system can rapidly provide notifications to the user explaining helpful, and important, information.

Example Features of the System

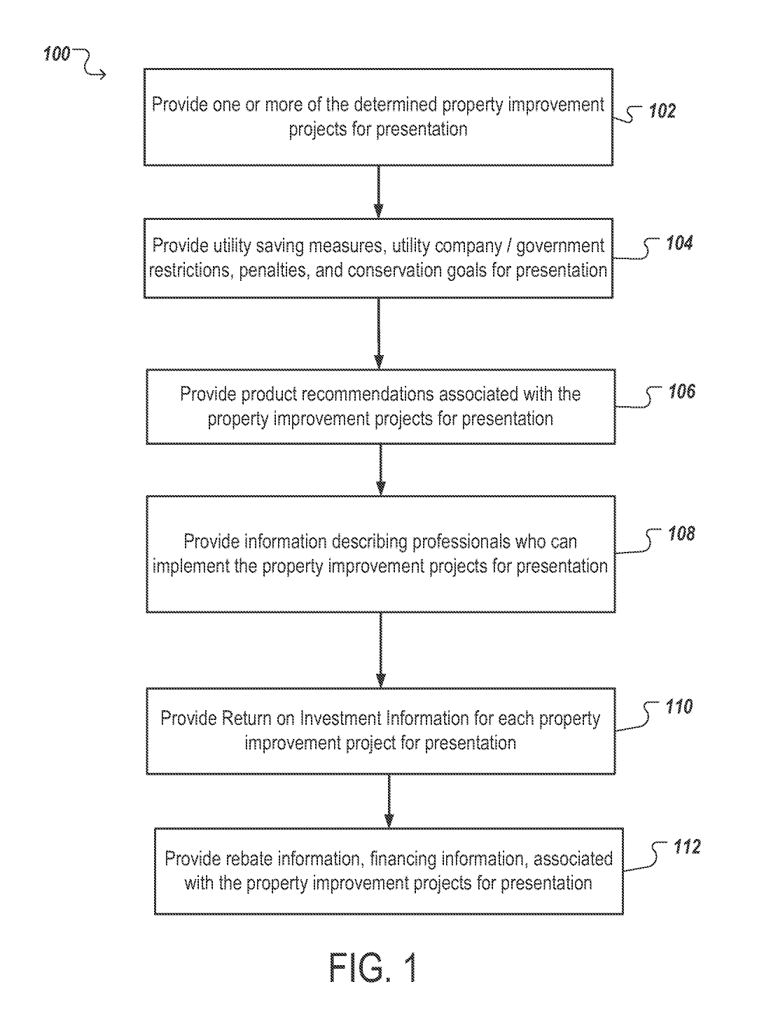

FIG. 1 illustrates a flowchart of an example process for property project analysis and data driven recommendations.

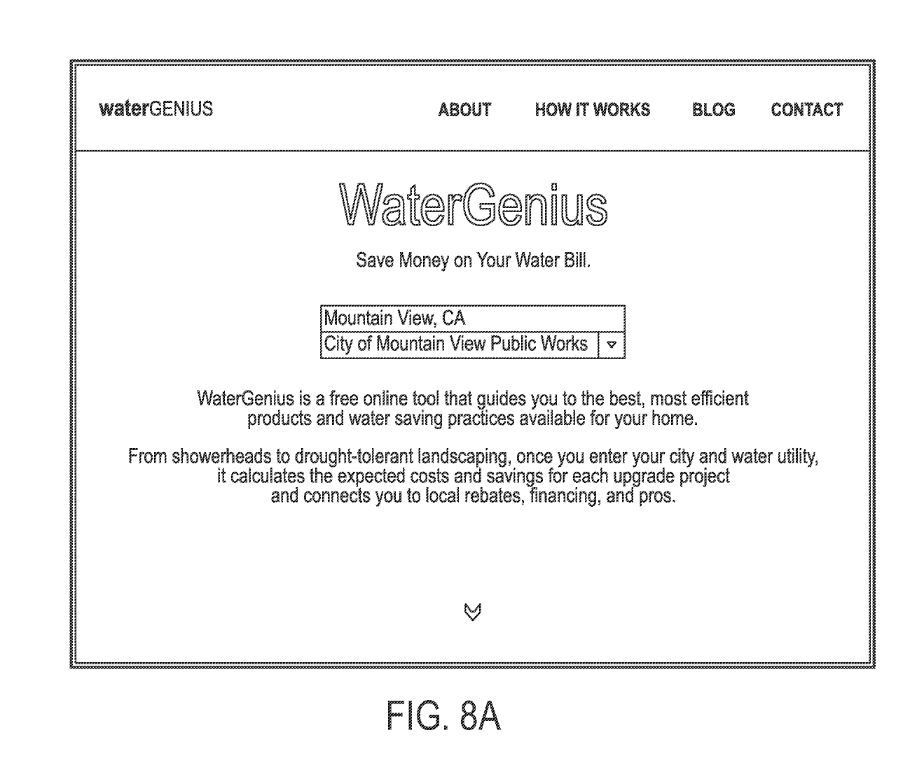

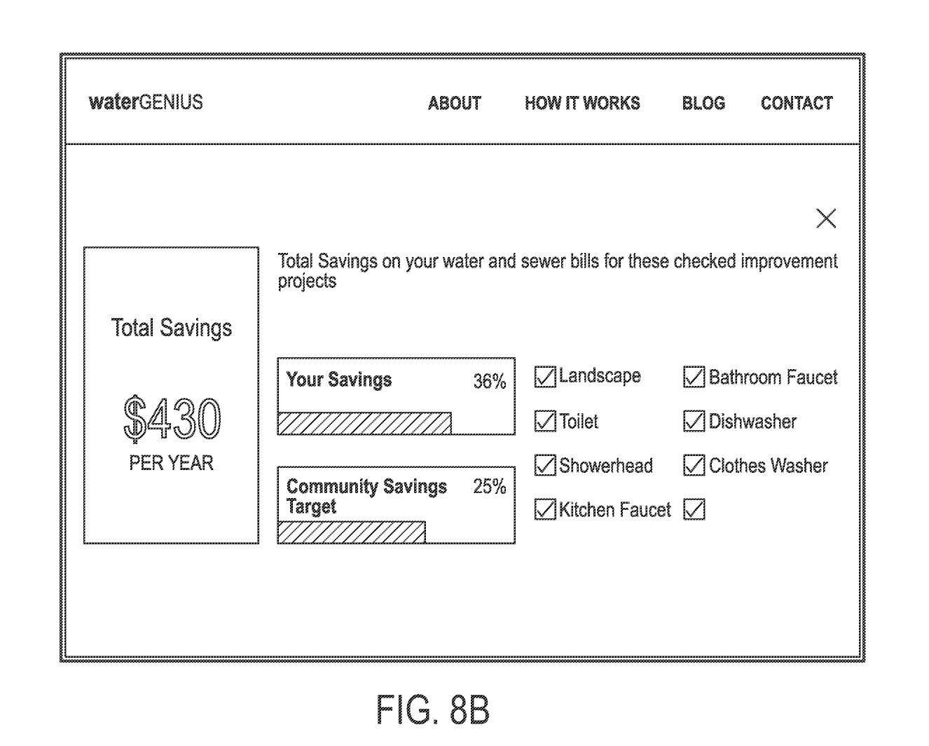

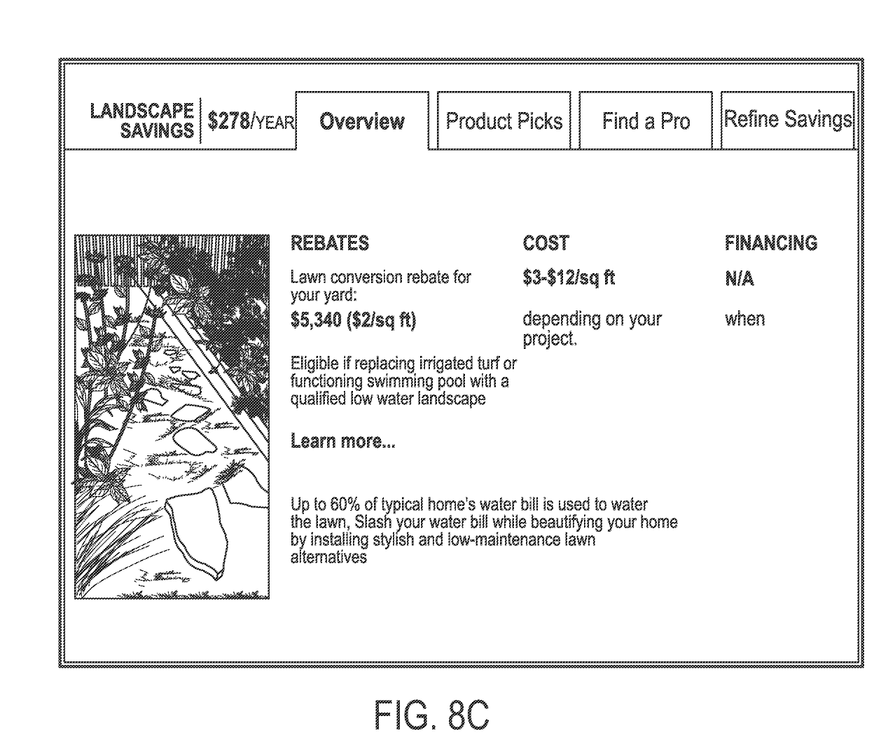

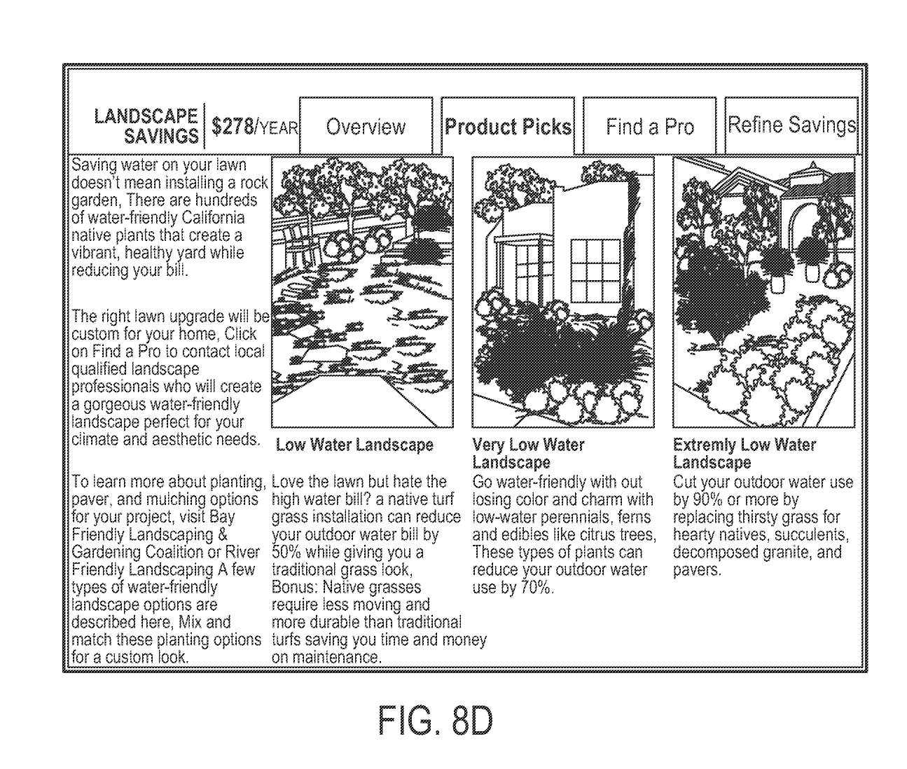

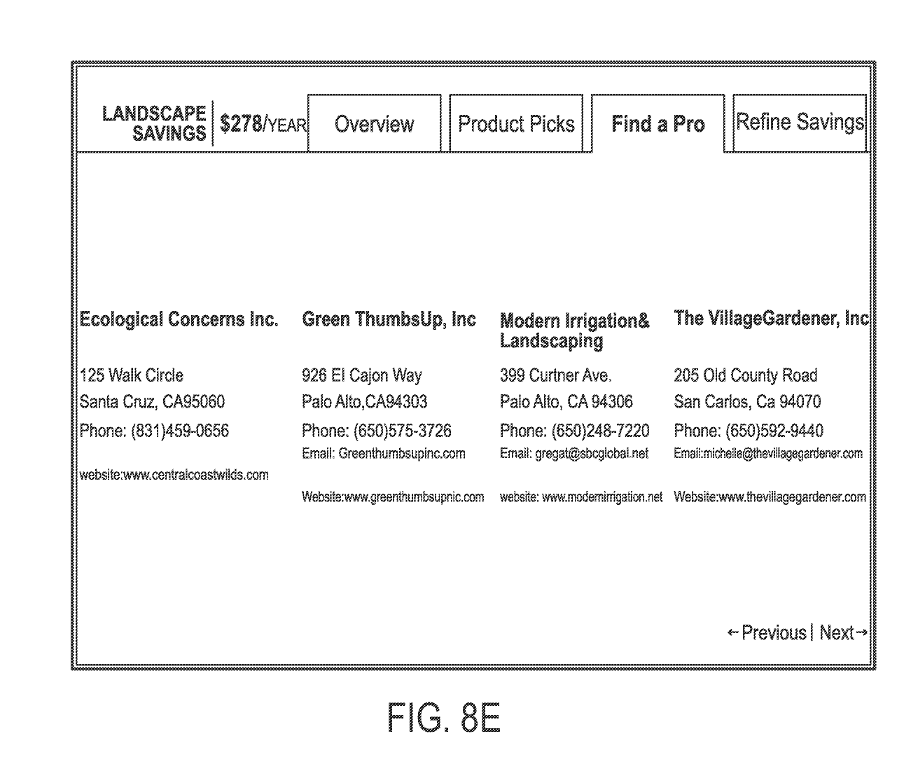

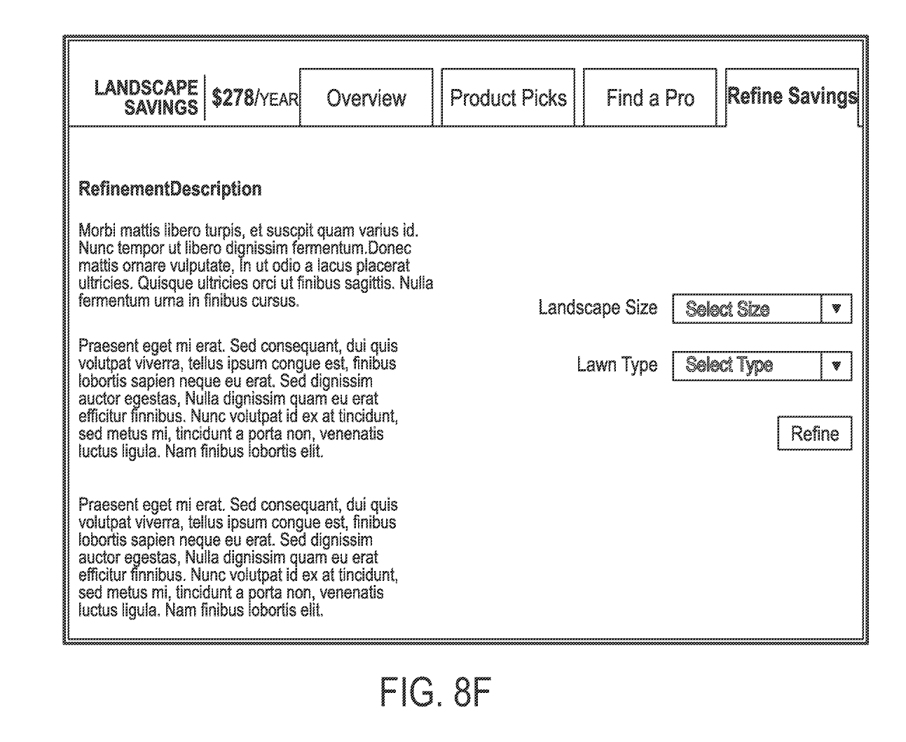

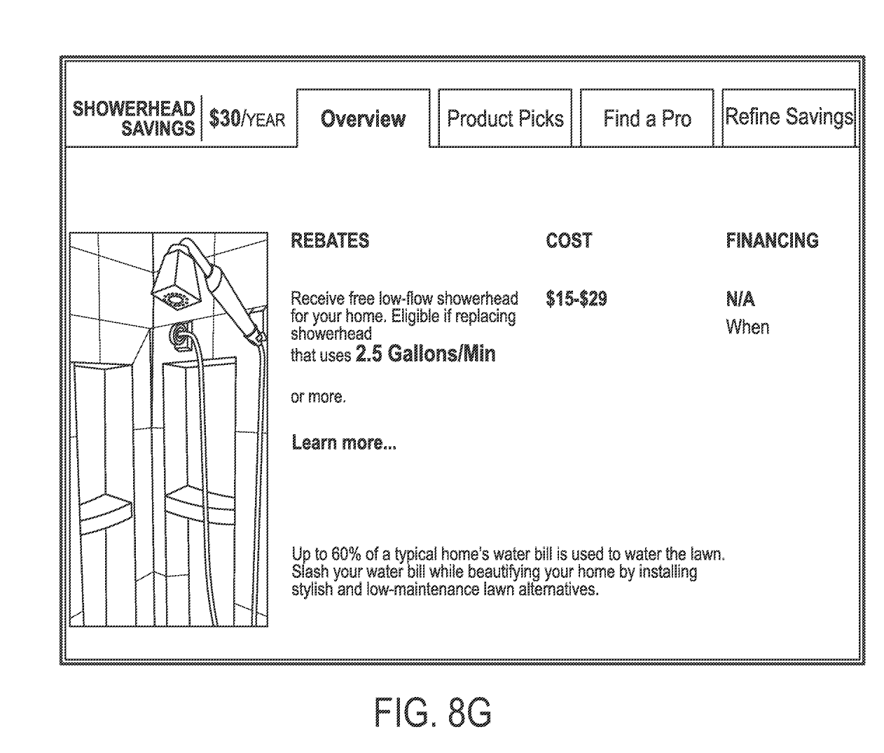

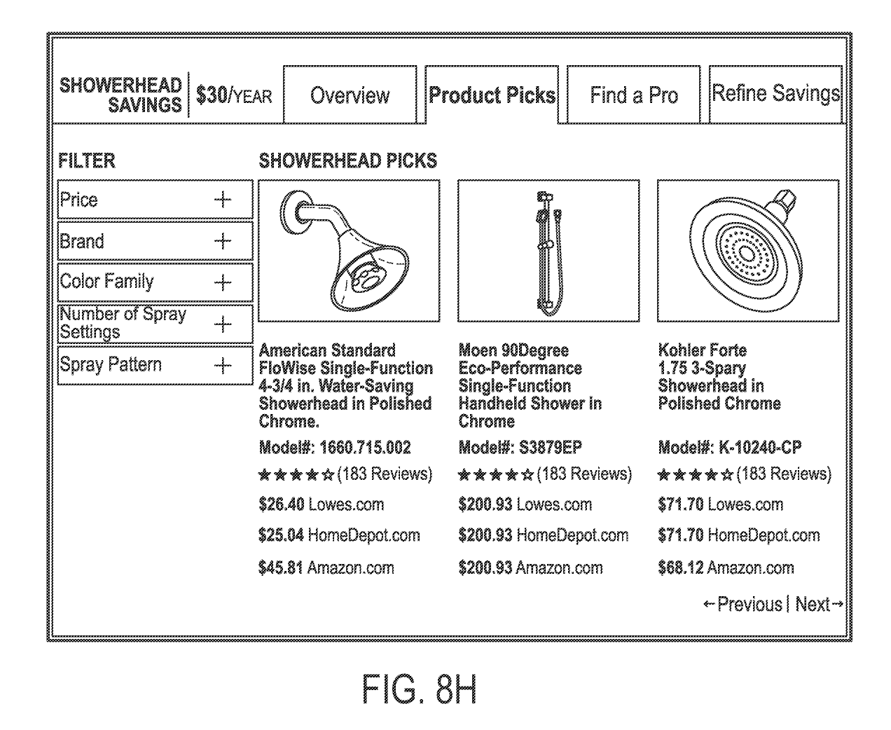

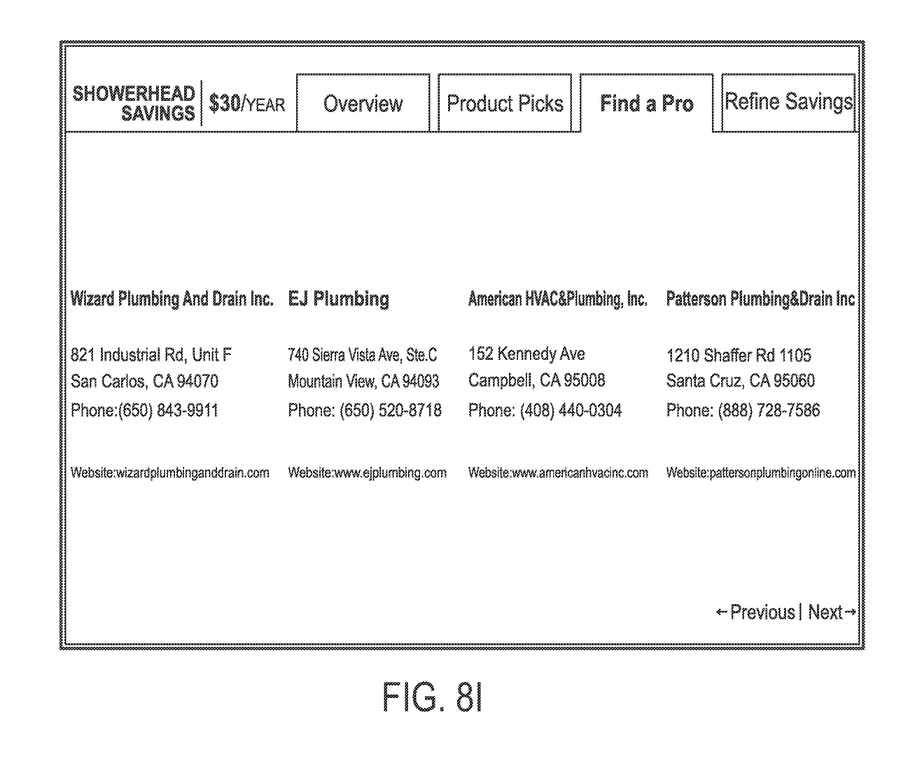

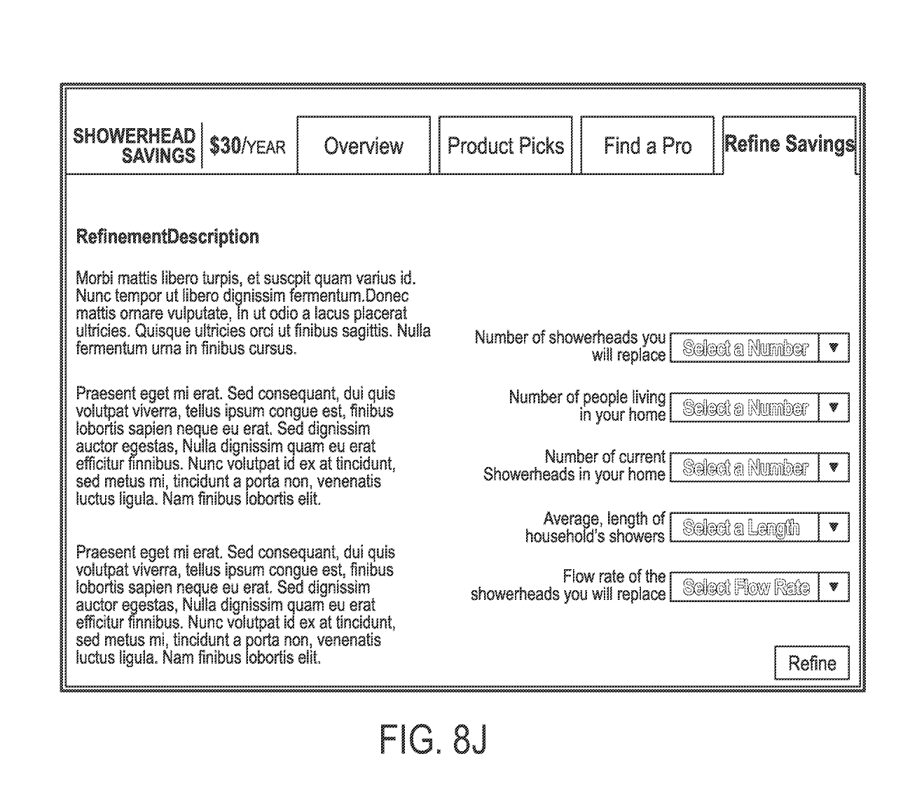

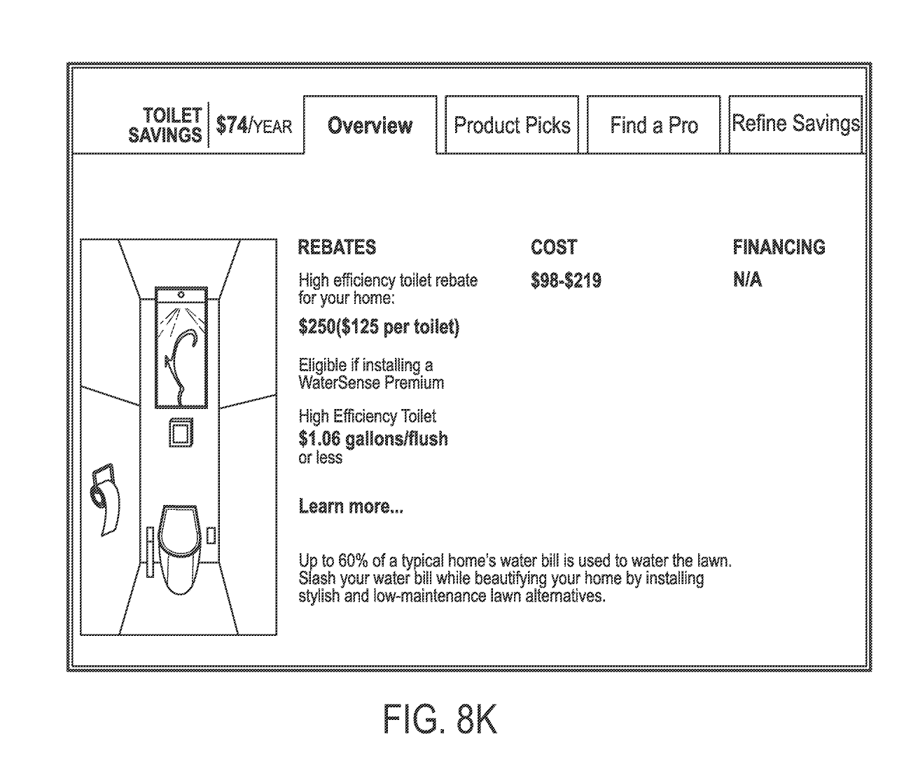

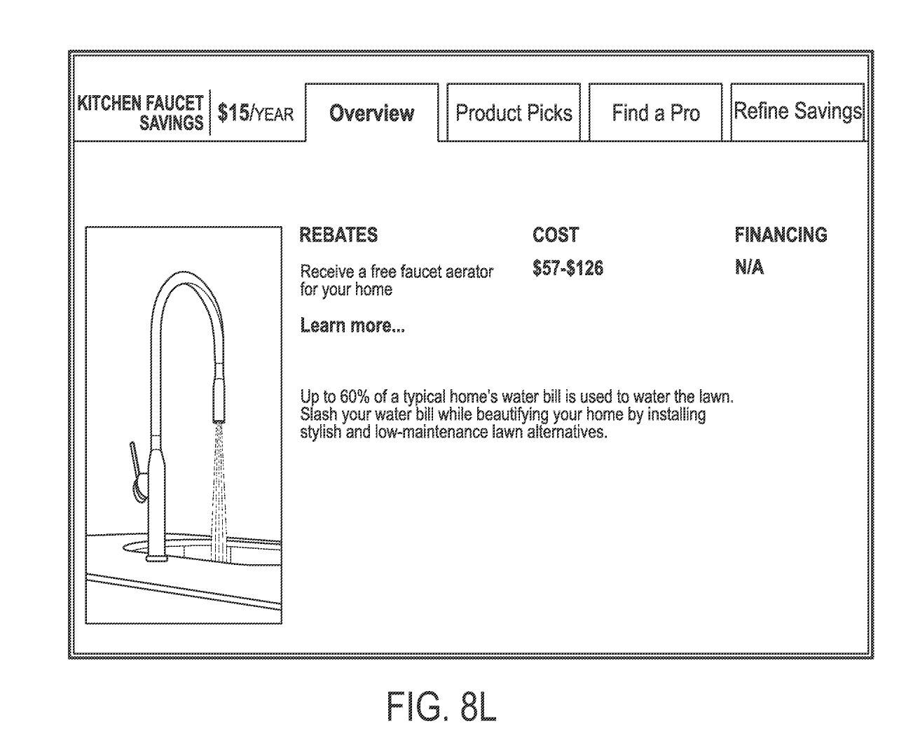

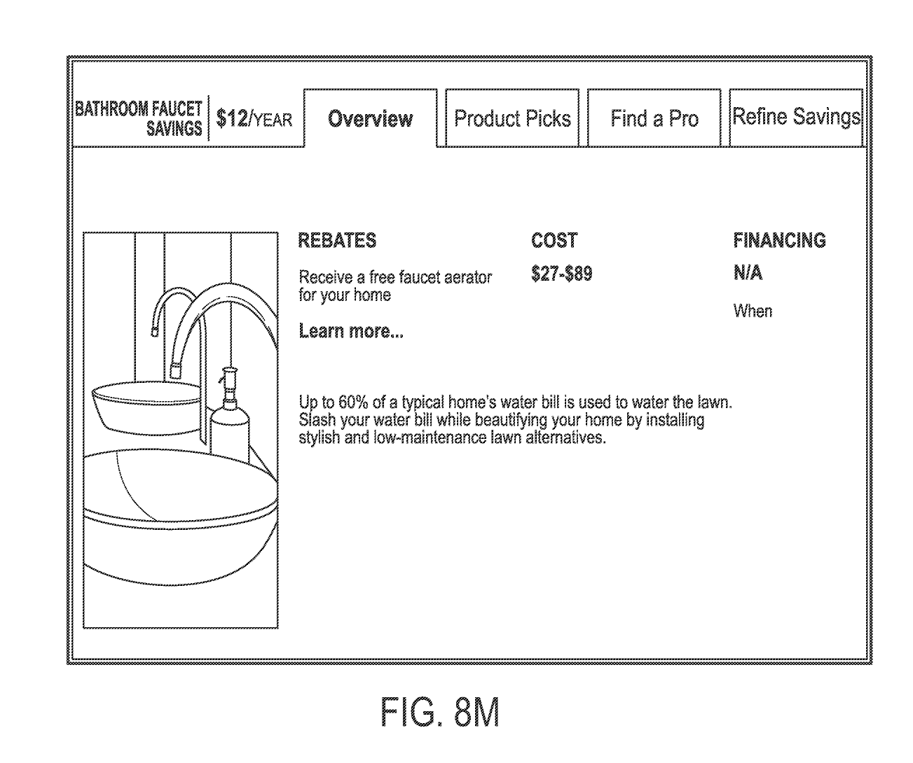

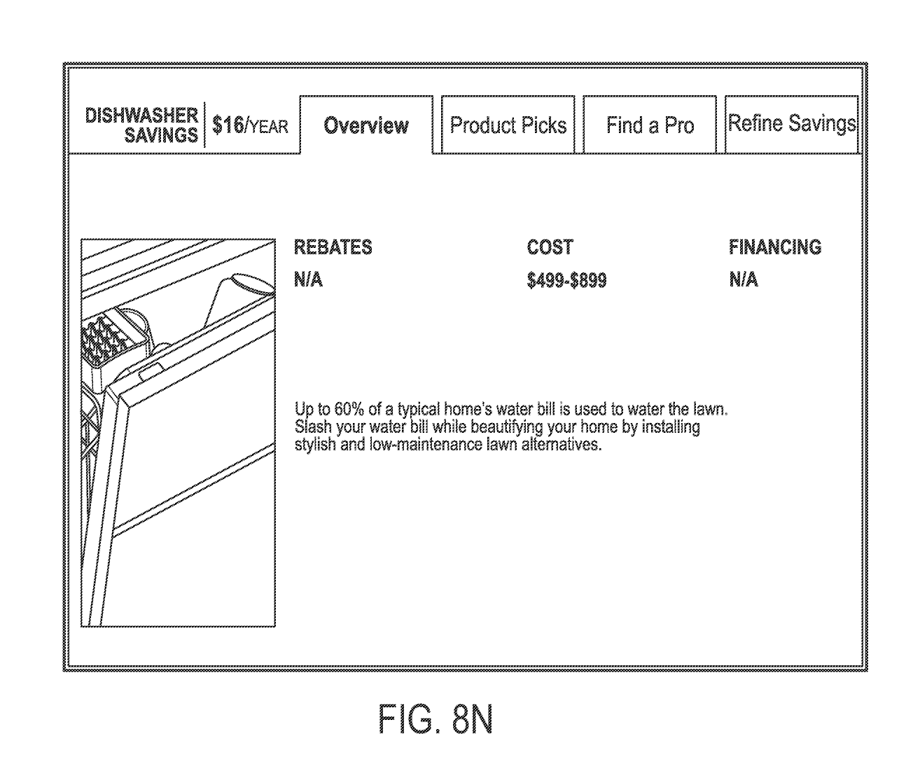

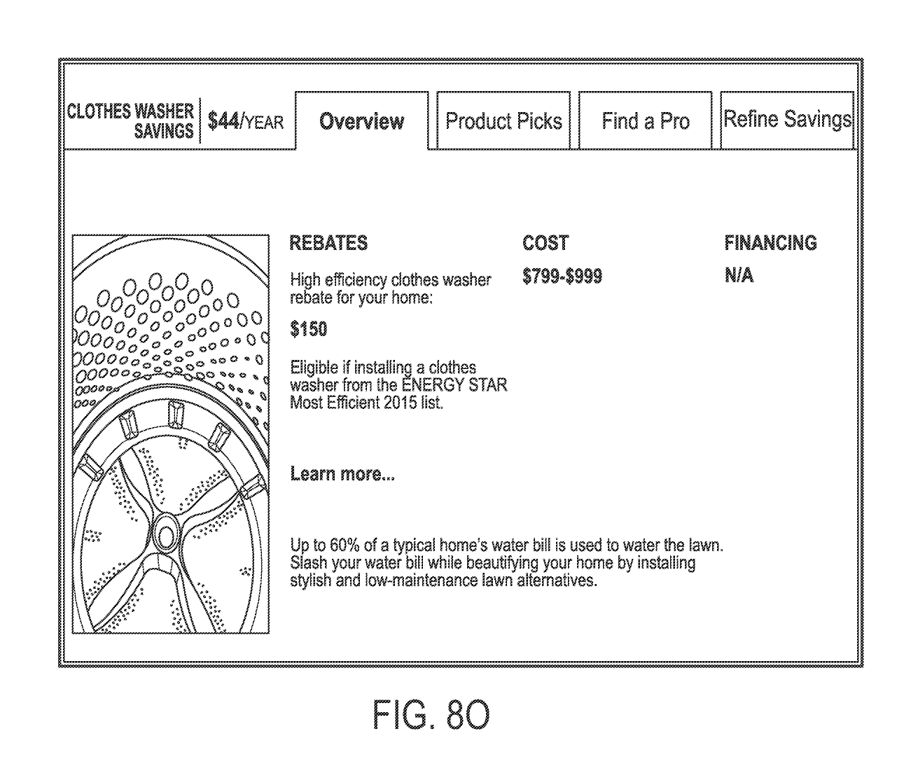

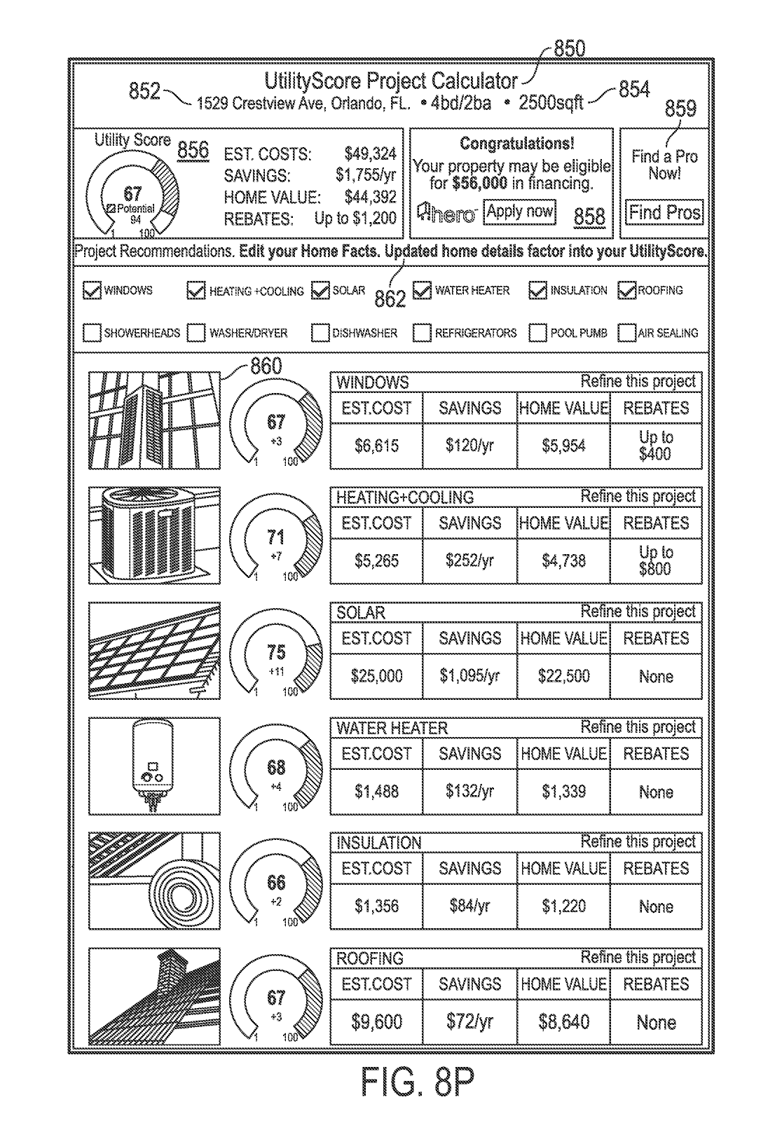

To quickly provide property improvement projects (block 102), the system can receive a specific address associated with a user's property. In some implementations, the system can receive minimal information from the user, including an identification of a particular area, e.g., zip code, city, and optionally a selection of particular utility companies in the area. An example of such a minimal, and easy to use, interface for identifying an area is illustrated in FIG. 8A. In this way, the user can receive useful information without inputting his/her actual address.

The system can obtain information specifying characteristics of the property associated with the address. For instance, the information can include a number of rooms, size of the property, number of bathrooms, and so on. As will be described, the system can store (e.g., maintain in one or more databases), actual property improvement projects that have been implemented at the property. For example, the system can determine that the property has particular upgraded appliances, which can be inputted by the user. In some implementations, each property can be associated with a property profile that specifies particular property improvement projects that have been implemented. In this way, the system can store information that would otherwise not be publicly accessible, and can determine more accurate information (e.g., utility usage) for the user.

If the system lacks a specific address (e.g., the user did not specify an address), the system can obtain information describing a property, such as a representative property with average characteristics of properties in the area. As described above, the information can describe characteristics including the number of rooms, size of the property, number of bathrooms, and so on.

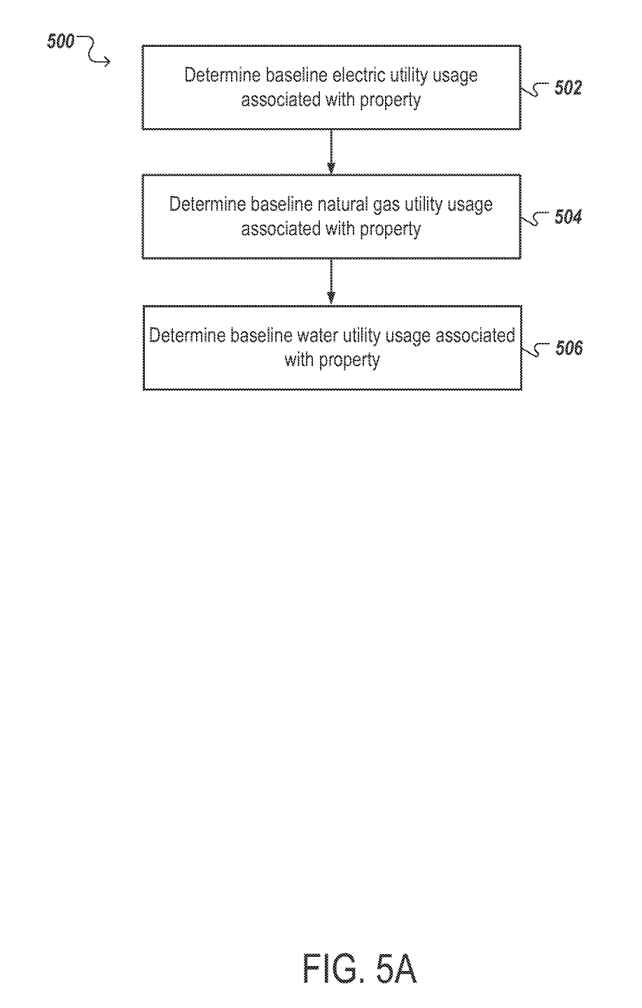

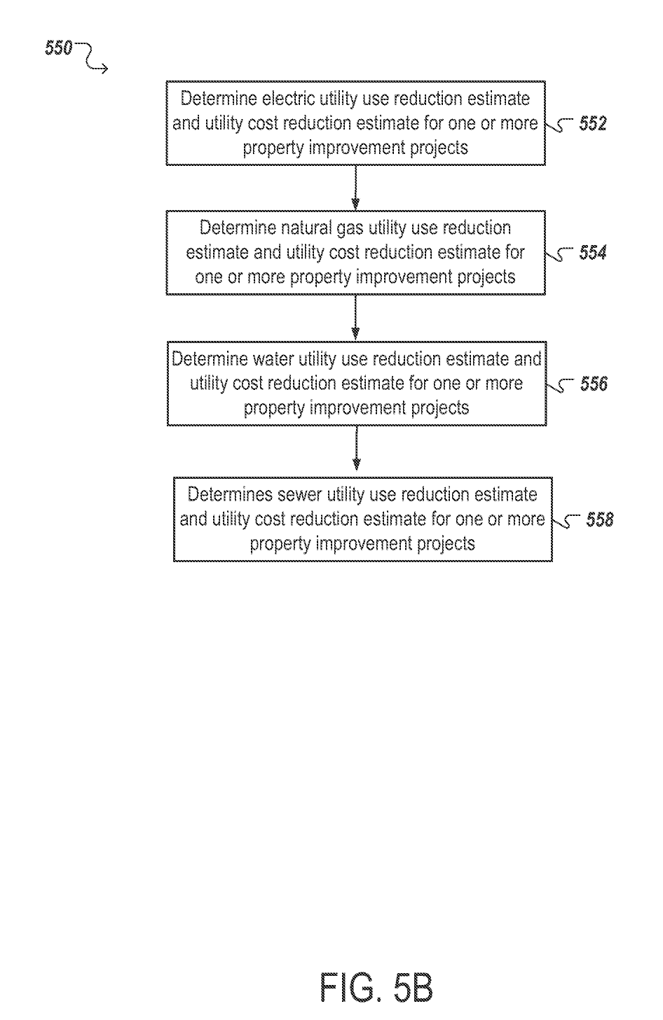

The system can then determine property improvement projects that reduce the user's utility usage and/or utility costs associated with the property and its location. In determining the property improvement projects, the system identifies utility costs and utility use estimates for specific products likely included in the property. The system can then determine utility cost, and utility use, savings for each improvement project by modifying, swapping out, or removing, one or more products associated with each improvement project. For instance, a bathroom improvement project can include upgrading toilets to a lower flow model, and thus reducing water utility use and cost. Determining utility use and utility cost reduction estimates for specific improvement projects is described below, with reference to FIG. 5A-5B.

The system can then generate a user interface that identifies the improvement projects, along with information identifying costs, utility cost savings and associated utility use savings, and any rebate information. Rebates are described below, with reference to step 112.

After generating and providing a user interface identifying property improvement projects, illustrated below in FIG. 8B, the system can provide information on reducing utility usage, any government implemented restrictions or penalties on utility usage. For instance, the system can obtain utility use saving measures, e.g., taking a shower of a particular length, utility cost saving measures, e.g., particular times to use high-electricity use applicants, and provide the saving measures to the user. As an example of a penalty, the government or utility company can mandate that lawns are only to be watered on specific days. Furthermore, conservation goals set by utility companies or government organizations can be provided to the user. The system quantifies the benefits of each measure, e.g., a utility cost reduction associated with implementing the measure, and also quantifies the harm associated with the penalties.

The system includes functionality to provide product recommendations, and product cost comparisons, of products involved in each improvement project (e.g., showerhead, type of lawn, washing machine) (block 106).

The system can obtain recommendations of specific products, e.g., brand and/or model of the product, of product types, e.g., showerhead, involved in each improvement project. The recommendations can be determined from user rating information provided to the system by users, or obtained from one or more websites of retailers, e.g., users can leave ratings for products they purchased. Additionally, the system can ensure that each recommended product meets, or exceeds, efficiency standards, e.g., ENERGYSTAR, and WATERSENSE.

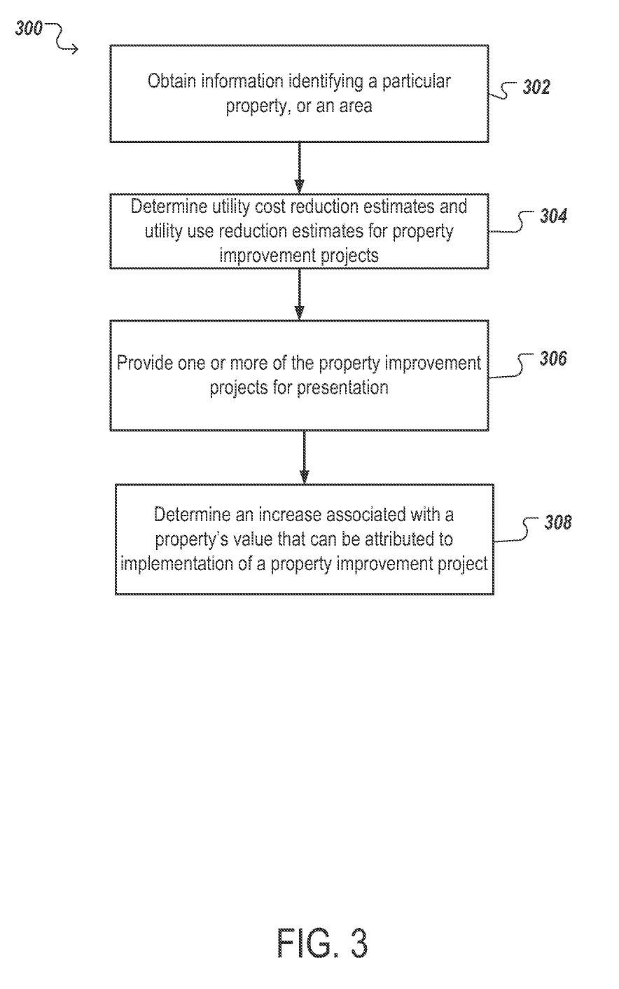

The system can then determine retailers, e.g., online retailers, brick and mortar retailers, that offer the product for the lowest cost, e.g., product cost coupled with shipping cost and tax. Providing recommended products is illustrated below, with reference to FIG. 8D and FIG. 8H, and further described in step 306 of FIG. 3.

Along with recommending products, the system can recommend specific professionals, in the user's area, that can perform the work required to implement each improvement project (block 108). The system can obtain ratings of professionals, e.g., ratings left by people that have used their services or professional ratings, and provide recommendations of highly rated professionals that meet professional licensing requirements for particular improvement projects. Providing recommended professionals is illustrated below, with reference to FIG. 8E, and further described in step 306 of FIG. 3.

The system is equipped to calculate complex and detailed Return on Investment (ROI) analysis and calculations for each improvement project (block 110). For instance, a user interested in upgrading his/her commercial building can receive detailed ROI information to help make decisions on implementing improvement projects. As will be described, the system can determine an expected increase in property value based on the implementation of the improvement project, providing a user with additional incentives to implement the project.

The system also can obtain rebate information, financing information, and government incentives, to provide to the user (block 112). As described above, rebate information can include tax refunds, or credits, from the government along with credits from utility companies, or reductions in pricing tiers from utility companies. The system can provide rebate information specific to each improvement project to the user. Additionally, any other government or utility incentives can be provided to the user. An example of rebate information is illustrated in FIG. 8C, and described below in FIG. 3.

Furthermore, the system can obtain financing information from one or more lenders, e.g., banks, micro-lenders, and provide the financing information, e.g., after purchase rates, down-payments required for the financing, to the user. The system can perform comparisons of various financing options, for instance the system can obtain property-assessed clean energy program (PACE) information relevant to a location of a user (e.g., a program that enables a local government to fund an up-front cost of improvements on commercial and residential properties, which are then paid back over time by the property owners), and compare the PACE information to other types of financing (e.g., unsecured personal loans, and so on). In addition, when a lender is considering providing financing for a home improvement project loan, the lender can utilize the system (e.g., an application on a user device, such as a mobile device, a widget on a web page, a dedicated software app, and so on), and obtain expected utility cost reduction estimates for a property improvement project. Charged with the knowledge that a loan associated with a property improvement project will enable a loan applicant to spend less on utility bills each month, and thus have more money in his/her pocket, the lender can have greater faith that the applicant will not default on the loan. In this way, the lender will have less risk when making the loan, and thus as described less concern with respect to a default on the loan. The lender can then prioritize loan applicants implementing home improvement projects that will lower utility bills (e.g., the lender can prioritize a loan for upgrading a hot water heater, air conditioning system, and so on, instead of a loan for upgrading cabinets of a home).

### OVERVIEW

This specification describes techniques to determine utility use estimates, e.g., an amount of each utility utilized, and associated utility cost estimates, e.g., estimates of costs associated with the utilities, for particular property improvement projects for a property, e.g., a specific home, a representative home in a particular area, a commercial property, a multi-unit dwelling, municipal property, and so on, and provide property improvement projects, e.g., modifying or upgrading a bathroom, kitchen, and so on, for presentation on a user device. In this specification, utility use estimates include determinations about an expected use of particular utilities, e.g., water, electricity, gas, in one or more time periods. Utility cost estimates include determinations for an expected cost of the utility use estimate according to utility rates set by utility companies.

In particular, a system can receive a selection of a particular address, and obtain information describing a property associated with the particular address. For instance, the system can obtain a year the property was built, a square footage of the property, a number of bedrooms, a number of bathrooms, square footage of land, occupancy numbers, and so on. The system can access stored property profile information for the particular address, with the profile information including particulars about the property, such as particulars inputted by a property owner. Additionally, a system can receive a selection of an area, e.g., a city, a metropolitan region, a zip code, instead of an actual address. The system can then obtain information describing a representative property (e.g., determined from a measure of central tendency of all properties of a same type, such as a home, commercial property, and so on) in the area, including, for example, a year the representative property was built, a square footage of the representative property, a number of bedrooms, a number of bathrooms, a square footage of land, a typical occupancy, and so on.

The system can then determine property improvement projects based on utility use estimates of products associated with each property improvement project, and obtain rebate information, e.g., rebates associated with utility companies, for the determined property improvement projects. In this specification, property improvement projects include any project that modifies, replaces, or eliminates, one or more products or systems in a property. Products and systems can include anything that is within the bounds of a property, e.g., landscape, toilets, lawns, pools, dish washers, washing machines, showerheads, furnaces, stoves, refrigerators, faucets, and so on.

As an example, a property improvement project can identify replacing incandescent light bulbs with low wattage light emitting diodes (LEDs). The system can compute estimates for utility use and cost associated with the old light bulbs, then for the new LED light bulbs, and provide information to a user identifying the improvement project, with associated projected savings, e.g., yearly, based on detailed knowledge or estimates of the user's particular utility rates, tiers, and/or use patterns. Savings can be refined for particular LED lamp or bulb choices, e.g., specific LED or light products, and can also be refined by more specific location and/or property structure information depending upon the user's desire to disclose such information.

System

FIG. 2 illustrates a block diagram of an example property improvement system 200. The property improvement system 200 can be a system of one or more computers, or software executing on a system of one or more computers. The property improvement system 200 receives requests, e.g., request 222, identifying particular addresses, or particular geographical areas (e.g., a city, metropolitan region, zip code, utility operating area, neighborhood, and so on) and provides property improvement projects 224 for a property associated with the particular address, or representative property in the area for presentation on a user device 220.

The property improvement system 200 includes a utility assessment engine 210 that can determine utility use estimates and utility cost estimates (which can also be associated with particular products) for a particular property specified in a request, or for a representative property in the area. To obtain accurate utility cost estimates, accurate utility companies, e.g., accurate for the area, need to be identified to obtain accurate utility rates. A user of the user device 220 can view a resource, e.g., a webpage in communication with or maintained by the property improvement system 200, that includes user selectable options to identify the area of interest to the user. Additionally, in some implementations, upon selection of the area, the resource can be updated to include identifiers of utility companies in the area. For example, the area of interest can be selected as a particular city. The utility assessment engine 210 can identify that the particular city includes three utility companies for a particular utility, e.g., water, and include a selectable option in the resource identifying the three utility companies. A user can then select from among the three utility companies, or can be provided with the option to provide an address or zip code of a property, and the utility assessment engine 210 can determine the applicable utility company. In this way, the property improvement system 200 can obtain applicable utility rates and/or usage tier information, e.g., utility costs set by the utility companies, for the area, e.g., city, of interest to the user.

For situations in which the utility assessment engine 210 lacks a specific address, the engine 210 can obtain information describing the representative property included in the area. To obtain the information, the utility assessment engine 210 can access a property information database 202 that the property improvement system 200 is in communication with, or, in some implementations, maintains. The property information database 202 stores, e.g., permanently or temporarily stores, for example, years that properties were built and/or renovated, square footage of properties, number of bedrooms in respective properties, number of bathrooms in respective properties, square footage of land area, and so on. In some implementations, the utility assessment engine 210 can obtain information from the property information database 202 by utilizing Application Programming Interface (API) calls to an outside system that maintains the database 202.

The utility assessment engine 210 can determine utility use estimates and utility cost estimates for various utilities, e.g., electricity, natural gas, water, sewer, for products or systems associated with property improvement projects, e.g., lights, showerhead, toilet, dishwasher, washing machine. To determine utility use estimates and utility cost estimates, the utility assessment engine 210 can obtain utility rates for the area, climate information for the area, and information identifying typical (e.g., average, median, or modal) use of utilities for the particular products.

To obtain utility rates for the area, the utility assessment engine 210 can access a utility/government information database 204 that the property improvement system 200 is in communication with, or in some implementations maintains. The utility/government information database 204 can store utility rates for different areas of a country, e.g., the United States. For instance, the utility/government information database 204 can store utility rates and associated utility companies for each city and/or county in the country, each metropolitan region, each zip code, and so on. Additionally, the utility/government information database 204 can store usage tier rates, monthly and/or seasonal utility rates, overage penalties, elevation charges, and so on. For example, the price of a utility such as natural gas can be higher in the winter months. In some implementations, the utility assessment engine 210 can identify the utility rates by automatically accessing a web site provided by utility companies and parsing the web site and applying analysis to determine utility rate information. The utility assessment engine 210 can then store the identified utility rate information in the utility/government information database 204. In some other implementations, utility rate information can be manually inputted into the utility/government information data base 204 for storage.

Similarly, the utility assessment engine 210 can obtain climate information for the area that includes the property associated with the particular address, or representative property. The climate information can be stored in a climate information database 206 in communication with, or maintained by, the property improvement system 200. The climate information database 206 can store climate information of various granularities for regions, e.g., climate information for each city, county, metropolitan region, state, or climate information from the National Oceanic and Atmospheric Administration. Additionally, the engine 210 can obtain climate prediction information for the particular address, or representative property, which can inform utility use estimates at later points in time. For example, an upcoming wet period of time, such as an El Nino, can reduce water usage of a property, as the property will water plants less often. Similarly, in some implementations, the engine 210 can determine spatial information of the particular property, including the particular property's orientation (e.g., with respect to one or more axes) and layout information. That is, the engine 210 can obtain (e.g., from a governmental or commercial database or system), information describing the particular property's location and orientation. In some implementations, the engine 210 can obtain imagery (e.g., satellite imagery, geo-rectified satellite imagery), and determine the particular property's layout and orientation. The engine 210 can modify the climate information based on the orientation and layout. As an example, a property with an east-west ridgeline, can maximize the length of the property, and using more windows on the southern side, can reduce the sun's heat on the property during summer (e.g., reducing air conditioning costs), while increasing the sun's heat on the property during winter.

After obtaining utility rates and climate information, the utility assessment engine 210 can obtain information identifying utility use of representative products, e.g., products with average characteristics for its product type, or systems associated with property improvement projects. That is, the utility assessment engine 210 can access a product information database 207 storing product information and associated utility use. For instance, a property improvement project can be associated with replacing a showerhead. The utility assessment engine 210 can identify, from the product information 207, that an average showerhead uses a particular amount of water per period of time, e.g., 1.5 gallons per minute, 2.5 gallons per minute, and so on.

To determine utility use of products, the utility assessment engine 210 can use information describing the particular property, or representative property. For instance, some products might be included more than a single time in the properties, e.g., based off a number of a bathrooms, number of bedrooms, number of rooms, square footage of rooms and backyard, and so on. The utility assessment engine 210 can determine that two showerheads are included in the particular property, from information specifying a number of bathrooms. Similarly, the engine 210 can determine that two showerheads are included in the representative property from information identifying an average bathroom count, e.g., two bathrooms, in properties in the area. The utility assessment engine 210 can then determine an expected utility use of the two showerheads, e.g., average flow of the showerhead, average electricity or natural gas costs to heat the water flowing out of the showerheads, and factor that into an overall utility use and utility cost of water, electricity or natural gas, for the property improvement project associated with replacing the showerheads.

The utility assessment engine 210 can also determine utility use of specific products or systems based on climate information. For instance, the utility assessment engine 210 can determine that a specific product, e.g., heaters, are used more often in the winter, e.g., from a number of Heating Degree Days, and compute a utility use and utility cost for the heater using the climate information and utility rates which can depend on the season.

In this way, the utility assessment engine 210 can determine utility use estimates and utility cost estimates for particular products associated with property improvement projects. Additionally, the utility assessment engine 210 can group particular products or systems together according to locations they might be in, e.g., kitchen, bathroom, backyard, and so on.

The utility assessment engine 210 can further modify the determined utility usages based on actual products, and/or property improvement projects, associated with the particular property. For instance, the engine 210 can determine that a particular showerhead used in the particular property utilizes a threshold amount less water per time, or that a washing machine included in the particular property is associated with better than average utility usage characteristics. A property owner can specify particular products in the particular property, such that accurate utility usage characteristics can be determined.

The property improvement system 200 includes a project generation engine 212 that determines property improvement projects 224 relevant to a property (e.g., a representative property, a particular property). As described above, property improvement projects are projects that potentially reduce use of one or more utilities and/or reduce an overall cost, e.g., over a period of time, of one or more utilities. Each property improvement project is associated with replacing, modifying, or eliminating one or more products or systems. For instance, a property improvement project can identify a project to replace a showerhead. Since a showerhead outputs, and thus uses, water, replacing the showerhead with a lower flow showerhead can reduce the use of a utility, e.g., water. However, since the showerhead also generally uses hot water, replacing the showerhead will also reduce the use of natural gas or electricity, e.g., to heat the water. Thus, a property improvement project can affect (positively or negatively) projected costs for more than one utility simultaneously.

To determine property improvement projects 224, the project generation engine 212 can access information identifying property improvement projects that potentially reduce utility use or utility cost for the particular property, or representative property in the area identified in the user request 222. For instance, the project generation engine 212 can identify that the particular property, or representative property, includes a grass-laden backyard, in an area where water costs are relatively high, e.g., compared to other water rates in other areas. The project generation engine 212 can then determine that a property improvement project to modify the backyard, e.g., remove grass and include less water intensive plants, is likely to reduce cost. In various embodiments, potential projects can be assessed and/or ranked based on expected utility cost reductions, return on investment (ROI). In some implementations, the project generation engine 212 can store information identifying potential property improvement projects, e.g., identifiers of the property improvement projects and information identifying products that can included in, modified by, or eliminated by, the project.

After identifying property improvement projects 224 likely to reduce utility use or cost, the project generation engine 212 can determine an average cost of each property improvement project, an estimated utility cost savings and utility use savings for each property improvement project, and also whether any rebates will apply to each property improvement project.

To determine an average cost, the project generation engine 212 can access information identifying average costs of the property improvement project. In some implementations, the project generation engine 212 can obtain quotes, e.g., expected, average, or typical costs, for each property improvement project from professionals associated with the area identified in the request 222, and/or average costs of products associated with the property improvement project.

Similarly, to determine an estimated savings for each property improvement project, the project generation engine 212 can identify products that will be modified, replaced, or removed entirely, during the property improvement project. Information identifying utility use of each identified product can be obtained, e.g., obtained from the product information database 207, and updated utility use can be determined for the identified products. A comparison of the utility use estimates for products prior to each property improvement project, and after each property improvement project, can be computed, and utility costs associated with the products can be computed to determine an overall savings, e.g., described below with reference to FIG. 5A-5B.

Additionally, the project generation engine 212 can obtain information identifying rebates associated with property improvement projects, e.g., specific products, from the utility/government information database 204. For instance, a water utility can give a rebate on water utility rates if a property includes a toilet with a flow amount below a threshold, e.g., 1 gallon, 1.3 gallons. In some implementations, the project generation engine 212 can automatically determine rebate information by parsing websites associated with utility companies, e.g., performing a pattern matching process on utility company websites for a word or phrase indicative of a rebate.

The project generation engine 212 can then provide information for presentation on the user device 220 identifying the property improvement projects 224, estimated costs, average savings, and rebates associated with the property improvement projects. In some implementations, the project generation engine 212 can provide a threshold number of property improvement projects, e.g., based on highest expected savings, ROI, and so on. Additionally, as will be described the project generation engine 212 can determine an expected increase in a property's value that can be attributed to particular property improvement projects being implemented.

In addition to the above, the project generation engine 212 can provide identifiers of professionals or tradespeople who can implement each property improvement project. In some other implementations, professionals can be identified based on user reviews of professionals. Similarly, the project generation engine 212 can provide a list of products associated with each property improvement project, e.g., determined from user ratings on one or more product rating websites, or from professional ratings from one or more professional rating services.

In some implementations, when providing the property improvement projects 224 the project generation engine 212 can generate user interfaces that identify the property improvement projects 224 and associated information. The user interfaces can be provided to a front-end system, e.g., a system that provides a web page to the user device 220, and the front end system can include the user interface in the web page. That is, the project generation engine 212 can be integrated into a third party presentation system in some embodiments. For instance, functionality described herein can be packaged, and provided to third party systems that host web pages, such that the third party systems can include described functionality as a web-application, or widget. Examples of user interfaces provided for presentation are described below, with reference to FIGS. 8A-8E.

The property improvement system 200 can receive refinement information 222 from the user of the user device 220, which can modify one or more analysis inputs described above. Refinement information 222 can include additional information regarding specific products or systems that the user of the user device 220 has in his/her property, which the system 200 can utilize to update a property profile associated with the user's property. As described above, the system 200 can determine property improvement projects 224 for a representative property in the area identified in the request 222, should the user not enter a particular address. By entering refinement information, the user can obtain a more accurate cost/savings estimate by providing more specific information regarding the property in question. For refinement information 222 identifying a specific address, the property improvement system 200 can obtain information describing the property located at the specific address, e.g., from the property information database 202. In this way an accurate number of bedrooms, square footage size, number of bathrooms, and so on, can be obtained. Additionally, refinement information can identify behavioral or lifestyle adjustments, such as a number of people that live in the property, ages of the respective people, average temperatures the user is to keep the climate of the property during different seasons, e.g., summer and winter, whether the user intends to generally occupy the property during the day, whether the user receives a special rate (for example, a medical baseline allowance), etc. Refinement information can identify physical features of the home, such as water heater type and fuel used, age of the air conditioning system, and so on.

After receiving refinement information 222, the project generation engine 212 can update information associated with each property improvement project, e.g., expected costs, expected savings, rebates, and so on. For instance, the user can identify that his/her property only includes a low flow toilet, and not a higher flow toilet as in the representative property. Thus, a property improvement project related to updating the bathroom, or toilet, can be modified to reduce the expected current utility costs and thus reduce projected savings from toilet replacement, e.g., since a toilet modification does not likely provide a good return on investment.

In some implementations, users can create user profiles associated with the property improvement system 200. These user profiles can be stored in a user information database 208, and identify property improvement projects 224 that specific users have implemented at their respective properties, reviews of professionals, reviews of products, specific addresses of properties owned by users, and so on. Information in the user information database 208 can be anonymized, and privacy protections provided, so that stored information can only be accessed by users associated with the information. In some implementations, users can select an option to share their reviews of professionals and products.

The property improvement system 200 further includes a professional interface engine 214, that provides access, e.g., through application programming interface (API) calls, to the property improvement system 200 by professionals, e.g., contractors, landscapers, realtors, and retailers.

For instance, a contractor can provide information to the property improvement system 200 identifying types of property improvement projects they can handle, and the professional interface engine 214 can provide identifiers of properties in a particular area that are likely to benefit from the projection improvement project (for example, having a projected utility savings above a threshold). The professional interface engine 214 can then generate documents that include a watermark or other identifier of the contractor, and information identifying one or more property improvement projects for specific properties in the area, along with associated information, e.g., expected savings, expected costs, rebates. These documents can then be mailed or otherwise provided to property owners of the specific properties, allowing for targeted notification of accurate utility savings.

Realtors can utilize the professional interface engine 214 to provide property improvement projects to potential purchasers of specific properties, or to provide products that can be included in specific properties. Additionally, if a property improvement project was recently performed by a seller, the realtor can identify the savings that the property improvement project generated, and provide that information to potential purchasers.

Retailers can utilize the professional interface engine 214 to obtain information identifying rebates associated with products that they sell. For instance, the retailer can provide identifiers of products sold by the retailer, and receive associated rebates. Additionally, retailers can receive information identifying property improvement projects, and display the property improvements projects in their stores to give consumers ideas on potential projects and utility costs, and utility usage, savings associated with the projects.

The professional interface engine 214 is in communication with, or maintains, a professional information database 209 that can store information associated with specific professionals, e.g., names/company information of professionals, logs of professionals or companies, rates professionals charge, types of property improvement projects they can handle or are licensed to handle, information identifying licenses of professionals. Additionally, the professional information database 209 can store information associated with retailers, including products they carry, prices of products, ratings of products, and any identifying information of the retailers.

The property improvement system 200 can further monitor user interactions with the system 200, for instance monitor interactions of users with respect to web-pages, electronic applications executing on user devices (e.g., “apps” downloaded from an application store), and so on. The property improvement system 200 can determine, for instance, that a threshold number of neighbors of a particular user have been researching and/or considering implementing a particular type of property improvement project (e.g., upgrade a water heater). The system 200 can provide information to the particular user indicating that the particular type of property improvement project has seen a recent uptick in activity. Additionally, if the system 200 maintains information describing actual property improvement projects that have been implemented by property owners, the system 200 can provide information to users specifying that, for instance, ‘20 of your neighbors have recently upgraded their water heaters,’ or, ‘20 of your neighbors are researching benefits of upgrading their water heaters,’ and can simultaneously present utility cost reductions to the user illustrating the benefits of the upgrade. In this way, the system can monitor and determine metrics associated with user interactions (e.g., a metric regarding users within a threshold distance of a user researching a particular property improvement project, product, and so on).

Similarly, the system can provide benefits to users based on maintaining actual product information associated with the user's properties. For instance, the system can provide information to the user stating that ‘Your [Product] is [X] years old,’ and can provide information to the user regarding the benefits of upgrading. As an example, the system can determine rebate information associated with the product, health benefits of upgrading, utility use and utility cost savings, and so on.

The above discussion has referenced databases, e.g., databases 202, 204, 206, 207, 208, and 209. It should be understood that each database can be partitioned into one or more databases, or one or more storage systems/subsystems, or combined into fewer databases. Additionally each database can be a part of another database, and the property improvement system 200 can be in communication with a multitude of other databases that store information for temporary or more permanent storage. Similarly in the discussion below data and information can be stored in any of the databases, or in memory accessible to the property improvement system 200.

Example Flowchart Processes

FIG. 3 is a flowchart of an example process 300 for providing property improvement projects. For convenience, the process 300 will be described as being performed by a system of one or more computers, e.g., the property improvement system 200.

The system obtains information identifying a particular property, or an area (block 302). The system receives a request to provide property improvement projects to a user of a user device. The system can receive an identification of a particular property (e.g., a property owned by the user, such as an entry of an address), or an identification of an area that the user is interested in, e.g., a particular city, a particular zip code, a particular metropolitan region, and so on. In some implementations, upon receipt of the particular area, the system can provide user selectable options identifying specific utility companies that provide utilities to that particular area. An example of a user interface in which a user can input a region and a utility company in the region is described below, with reference to FIG. 8A.

The system determines utility cost reductions and utility use reductions for property improvement projects for a property, e.g., the particular property, a representative property, in the area (block 304). Upon receiving a particular property, the system obtains information describing the property, including a year built, square footage, number of rooms, number of bathrooms, square footage of a backyard, heating type (electric or gas), and so on.

Similarly, upon receiving the area, the system obtains information describing a representative property in the area, e.g., average typical year properties were built in the area, average square footage, average number of rooms, average number of bathrooms, average square footage of a backyard, average heating type (electric or gas), and so on. In various embodiments discussed herein, averages can be variously replaced with other measures of central tendency including medians, modes, and so on.

As described above, each property improvement project modifies, replaces, or removes, one or more products. The system therefore computes utility use estimates for each product associated with a particular property improvement project that has representative characteristics for its product type (e.g., a showerhead has an average flow rate, a toilet has an average amount of water used for each use, and so on). The system then computes utility use estimates for products that will be in the property after the particular property improvement project, e.g., a showerhead that uses less water, a low flow toilet that uses less water. The difference in utility use informs utility cost savings and utility use savings for the property improvement project. Optionally, as described above the system can store actual product information associated with the particular property, such as a model number (e.g., SKU) of a product, efficiency information associated with products, precise numbers of products (e.g., the property can include two bathrooms, but have 3 bathroom sinks and faucets), and so on. The system can utilize this actual product information to better determine utility cost estimates.

The system identifies an expected utility usage of products based, in part, on the obtained information describing the property. For instance, a property with more square footage will be expected to use more lights and thus more electricity, and a larger property with electric heating will be expected to use more electricity than a smaller property. Additionally, the system can utilize assumptions about properties in this determination. For instance, the system can assume that there are a particular number of occupants in the property, e.g., 2, 3, 4, that the thermostat in the property will be set at a particular number, and whether the property will be occupied during the day. As discussed above, such assumptions can be refined by the user to obtain a more accurate result, and additionally the system can store information (e.g., entered previously by the property owner, a real estate agent, a contractor, and so on) that specifies the actual number of occupants, and so on.

Similarly, to determine utility use estimates of products prior to implementing a property improvement project, the system can obtain information identifying representative characteristics of products across products of its type, e.g., an average showerhead can have a flow of 2.5 gallons per minute. Alternatively, if the system stores actual characteristics of products, the system can prefer the actual characteristics when determining utility use estimates.

The system computes utility use estimates for products associated with property improvement projects in particular months and/or seasons. Since utility usage will depend on climate information of seasons, e.g., natural gas usage can rise in the winter, the system obtains climate information for the area that includes the property, e.g., from the International Energy Conservation Code climate zones, and/or from information identifying Cooling Degree Days or Heating Degree days of each month for an area that includes the property. The system can utilize this information to determine, for example, that the winter months, e.g., months that include a larger quantity of Heating Degree Days, will be expected to use more natural gas on a heater, e.g., if the property makes use of a natural gas heater, but potentially less electricity on an air conditioner or freezer. The system can also access weather prediction information to determine that one or more upcoming months, weeks, seasons, are going to vary from the averages indicated by Cooling Degree Days and Heating Degree Days. The system can utilize the weather prediction information to modify the climate information, providing the user with more accurate utility use estimates.

After computing estimated usages of respective utilities for products associated with property improvement projects, e.g., both before implementing a property improvement project and after implementation, the system obtains utility rates for the area, e.g., rates set by public, private, or municipal utility providers. Since utility rates can fluctuate depending on season and month, the system obtains specific utility rates for each month and/or season.

The system then determines utility cost reductions for each property improvement projects, based on the utility rates and the utility use estimates for associated products, e.g., before and after implementation. That is, for each property improvement project, the system applies the utility rates to associated products with representative characteristics, or actual characteristics specific to the property, e.g., products prior to implementing the improvement project, and applies the utility rates to products after the property improvement project. The system computes a difference between the utility costs of products after implementation of the improvement project, and prior to implementing the improvement project. The difference in utility cost is the utility cost reduction that can be obtained by implementing the property improvement project.

As an example, a property improvement project can identify replacing a washing machine. A representative washing machine can use 35 gallons of water per load of laundry. The property improvement project can identify replacing the representative washing machine with a new one, which uses 10 gallons of water per load of laundry. Based on this difference, the system can compute the difference in water usage over a period of time, e.g., a year, with information describing average uses of washing machines in the period of time, e.g., people use a washing machine three days per week on average. The system can then compute an expected utility cost reduction using the utility rates for the area, and moreover using the specific marginal usage tier that the property is expected to be in. In many instances, the marginal usage tier rate can be much higher than the property's average rate.

Additionally, the system obtains rebate information associated with the potential property improvement projects to determine whether the expected utility costs can be further reduced. Rebates can include rebates provided from governmental organizations, e.g., tax reductions (which estimates can be refined if the user supplies tax rate information), and rebates provided from utility companies, e.g., reductions in utility costs. The system determines whether any rebates apply to the property improvement project, e.g., apply to specific products, or to the property improvement project as a whole. In some implementations, the system can store information identifying rebates associated with property improvement projects, or in some implementations, the system can store text identifying rebates, e.g., parsed from government or utility company websites, and match names of products associated with property improvement products to the text.

In some implementations, the system can utilize multiple products associated with different costs and utility use estimates for each property improvement project. For example, for a property improvement project identifying replacing an old washing machine with a new one, the system can determine utility use estimates for multiple washing machines at different price points, e.g., pricing tiers. For instance, a first washing machine with a high price point can use 10 gallons of water per usage, and a second washing machine with a lower price point can use 15 gallons of water per usage. The system then determines utility cost estimates for the different products.

The system provides one or more property improvement projects for presentation on the user device (block 306). In some implementations the system identifies a threshold number of property improvement projects that are determined to reduce utility costs, or utility usage, e.g., 3, 5, 8, and so on. In some other implementations, the system can provide all of the tested property improvement projects for presentation, which can be ordered according to utility cost reduction, and/or utility usage reduction, or only those projects with a cost, savings, ROI, or payback period above/under a threshold. An example of a particular property improvement project provided for presentation is described below, with reference to FIG. 8B. If the system has access to information specifying property improvement projects that have been implemented, the system can determine not to present the property improvement projects. Additionally, as will be described in FIG. 8P, the system can determine a score associated with each property improvement project, indicating an efficiency associated with utility usage. In some implementations the system can present a top threshold number of property improvement projects associated with top scores, or top scores normalized according to cost of implementation.

The system can include, in the presentation, textual information associated with each property improvement project. For instance, the system can utilize weather prediction information to supplement the presentation. As an example, the system can include textual information specifying that a particular property improvement project, given a present time, would normally provide expected utility use and cost reductions of particular amounts, but given that upcoming months are going to be substantially wetter than average, the use and cost reductions are lower. A user can then look to a different more pressing property improvement project. Similarly, the system can specify that, while the property improvement project normally provides a particular use and cost reduction, these values are substantially increased in the next several months based on predicted weather information.

The system further obtains information identifying professionals that can implement each property improvement project, and can provide the information for presentation on the user device, e.g., upon receiving user input. In some implementations, the professionals can be identified by ratings on one or more user submitted rating sites, and/or one or more professional rating sites. Information associated with the professionals, e.g., name, license number, website, phone number, can be provided. An example of information identifying professionals provided for presentation is described below, with reference to FIG. 8E

The system obtains recommended products associated with each property improvement project, and provides them for presentation, e.g., upon receiving user input. The recommended products can be products, of the same product types, recommended on user submitted rating sites, professional rating sites, and/or retailers, e.g., users of the retailer can provide ratings for purchased products. An example of recommended products provided for presentation is described below, with reference to FIG. 8D and FIG. 8H.

Additionally, the system can identify different cost pricing tiers of each property improvement project. For instance, the system can provide information identifying that a more expensive product required in a property improvement project will provide a greater utility cost reduction. Users can then budget the property improvement project using a pricing tier they are comfortable with.

In some implementations, the system can provide measures that property owners can implement to reduce utility usage and/or utility costs. For instance, the system can provide information identifying times in the evening in which electricity tier rates are reduced in cost, or efficient setting for appliances or systems in use (e.g. a wash cycle setting or thermostat setting). Similarly, the system can obtain restrictions on utility usage for the specific area. For instance, if the user identified a particular city, the system can provide information identifying that the city restricts watering lawns to particular days of the week. The system can also provide a fine or fee associated with violating the restriction.

Users can enter refinement information that provides more specific detail about their properties, e.g., an actual address of a property, specific products, number of bathrooms, square footage of property/yard.

The system determines an increase associated with a property's value that can be attributed to implementation of a property improvement project (block 308). As described above, property owners may be incentivized to implement a property improvement project if quantifiable benefits are provided to them, such as a benefit to a property's value. Determining an increase associated with a property's value (e.g., steps to compute the increase) is described below. The increases can be provided for presentation to a user, and can be presented next to costs associated with implementing the property improvement project. Optionally, the system can present financing options (e.g., as described above), such that the user can quickly determine overall cost, cost per month (e.g., according to financing), and expected benefit to his/her property.

To determine an increase in a property's value, the system determines:

Project Asset Value=Total Project Cost*Project Asset Score*Scope

As will be described, the Project Asset Value is a monetary present value of a project when executed at a given time (past, present or future) in a home property influencing its current valuation, and represents an added value to a property's overall value.

Total Project Cost, included in the above calculation, is a comprehensive budget standard estimation for a given type of project relevant to the location of the real estate property, and Scope is a percentage of completion of a property improvement project considering its full potential. For instance, if 100% of a home's window area is being replaced in a window project, the Scope is 1.00; if 55% of a home's window area is being replaced, the Scope is 0.55.

The Project Asset Score is the potential impact index on value of a project to be performed at a given time (past, present or future) on a real estate property related to its total cost of execution. Project Asset Score can therefore represent a connection with, such a correlation with, an increase in a property's value. That is, since Project Asset Score is linearly proportional to Project Asset Value, the ‘score’ (e.g., Project Asset Score) can be utilized as a quick reference point for a relative increase in a property's value. Optionally, the score can be identified when presenting information describing property improvement projects, or optionally the score can modified by a total cost (e.g., average total cost) of implementing the associated project. In this way, property improvement projects can potentially be ranked or ordered according to the score and increase in property value.

To determine the Project Asset Score for a real state property (RSP), where the property improvement project P is completed on a given date t the system computes:

$$PAS ( t , P , RSP ) = \frac{VE ( t , P , RSP )}{TCE ( t , P , RSP )}$$

where VE represents a total value expected of the property improvement project, and where TCE represents total cost/investment of the property improvement project on a specific real state property, which is executed to finish on a date t. The units of VE and TCE are currency. In an embodiment, TCP and TCE differ in that TPC is based on statistical information and TCE is specific to a real estate property. RSP specifies information including one or more of geolocation, lot area, home area, year built, postal code, installation date of current solution for the specific project if applicable. The unit of RSP comprises information regarding the real state property and accordingly each element will have a specific unit.

To determine VE, the system computes:

$$VE ( t , P , RSP ) = {C}_{1} ( t , P , RSP ) * ( S ( t , s , P , RSP ) - M ( t , P , rsp , lf ) + F ( t , P , RSP , lf ) - LV ( P , {t}_{op} , {l}_{op} ) + RV ( t , P , RSP ) + {C}_{2} ( t , P , RSP ) ) * O ( t 1 , RSP )$$

### Where:

C₁(t,P,RSP) is Comfort index 1 by project (P), date (t), and property location (RSP), with a dimensionless unit. This index is calculated according to a statistical analysis of given standard project types, and can represent a historical trend indicator associated with a property improvement projects location (e.g., value at a location).

C₂(t,P,RSP) is Comfort index 2 by project (P), date (t), and property location (RSP), and with a dimensionless unit. This index is calculated according to a statistical analysis of given standard project types, and can represent a historical trend indicator associated with a property improvement projects location (e.g., value at a location).

S(t, s, P, RSP) represents Net present value of all expected savings during the lifetime of the property improvement project (P) in a real state property (RSP) with a project scope (s) and finished on a specific date (t). The Savings (S) parameter is the result of summing the present value of the operation costs of the existing products being replaced, and subtracting the operation costs of the products as result of executing the property improvement project (P) for all periods (for instance, months) during the lifetime of the property improvement project. Thus, if a property improvement project does not generate any savings as it is a first-time installation of the project, and does not replaces a function supplied by a current product, then only its operation costs are considered. Savings are calculated considering a scenario based on trends during the lifetime of the property improvement project (P).

S(t,s,P,RSP)=NPV((OC_{current}(tᵢ)−OC_{new}(tᵢ))*Accᵢ)

Where:
NPV( . . . )=Net present value considering a rate index for currency calculations for given cash flow, and has units of monetary currency.
OC_{current}(tᵢ)=Operation costs for current solution for period tᵢ, and has units of monetary currency.
OC_{new}(tᵢ)=Operation costs for current solution for period tᵢ, and has units of monetary currency.
Accᵢ=Scenario index for period tᵢ, and has dimensionless units.

M(t, s, P, RSP) represents Maintenance, net present value of all specific expenses for the implemented property improvement project as result of the execution of the project not considered in the Savings calculation. The unit is in monetary currency.

M(t,s,P,RSP)=NPV((M_{current}(tᵢ)M_{new}(tᵢ)*Bccᵢ)
NPV( . . . )=Net present value considering a rate index for currency calculations for given cash flow, and has units of monetary currency.
M_{current}(tᵢ)=Maintenance costs for current solution for period tᵢ, and has units of monetary currency.
M_{new}(tᵢ)=Maintenance costs for current solution for period tᵢ, and has units of monetary currency.
Bccᵢ=Scenario index for period tᵢ, and has dimensionless units.

F(t, s, P, RSP) represents Net present value of all operation costs of existing products (if applicable) during the lifetime of the property improvement project. The existing product might be replaced partially or fully. Operation costs are to be considered as the minimal investment needed to keep the main function of the current products covered. If the current products reach their lifetime before the lifetime value of the property improvement project, a minimal investment to keep the function covered should be considered until the lifetime value of property improvement project is reached. The unit is in monetary currency.

LV(P,tₒₚ,lₒₚ) represents Pending value of the existing products that is subject to be replaced totally or partially by the property improvement project. The system computes the pending value as the net present value of the pending functional depreciation of the current products (considering their installation date:tₒₚ) until the lifetime of the current products are reached (lₒₚ). Functional Depreciation might be calculated as the US Appraisal Institute establishes. The unit is in monetary currency.

RV(t, tₒₚ,lₒₚ,RSP) represents Recovery value when the property improvement project is finished (t) of current products (considering its installation date tₒₚ and lifetime lₒₚ) at a given location (RSP) if any. The unit is in monetary currency.

Referring back to

$$PAS ( t , P , RSP ) = \frac{VE ( t , P , RSP )}{TCE ( t , P , RSP )}$$

Once the system computes, as described above, VE, the system computes TCE, which represents the total cost of execution of the property improvement project.

That is, the system computes:

TCE(t,P,RSP)=NPV(Labor+Material+Project related expenses)

Where,

NPV, is calculated as the net present value at (t) date of all the expenses necessary to execute the property improvement project.

Labor, includes all expenses related to human labor necessary to execute the project (P) so that it can be finished at a given time (t) considering specific property details (RSP).

Material, includes all expenses related to hardware/software/raw material necessary to execute the property improvement project (P) so that it can be finished at a given time (t) considering specific property details (RSP).

Project related expenses, include permits and indirect costs due to the execution of the project.

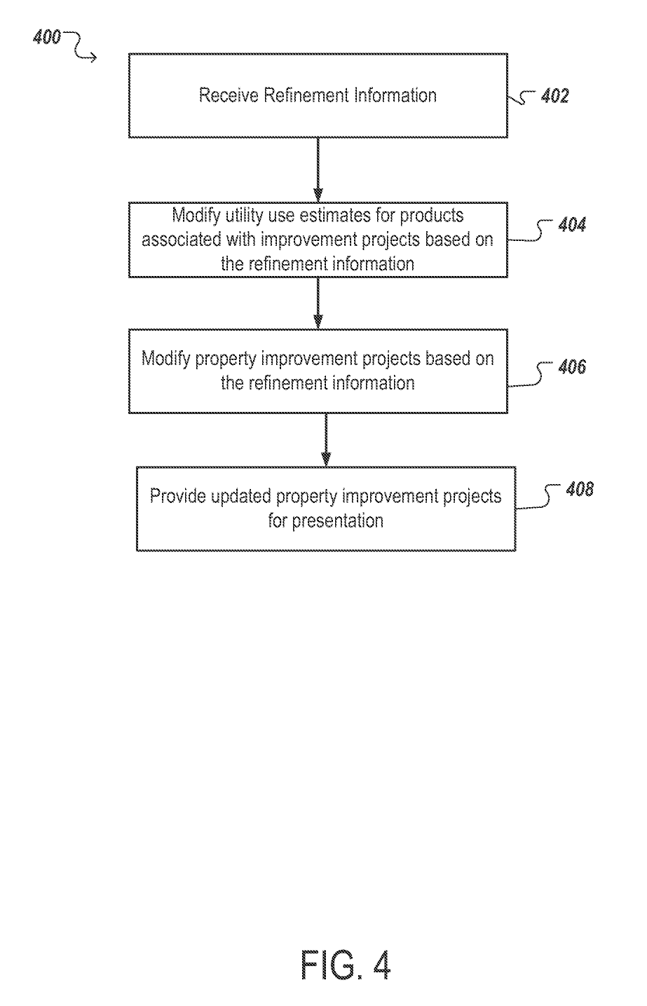

FIG. 4 is a flowchart of an example process for modifying property improvement projects based on user refinement information. For convenience, the process 400 will be described as being performed by a system of one or more computers, e.g., the property improvement system 200.

After providing property improvement projects for presentation, the system can receive refinements to information describing a specific location of the property, products included in the property, square footage of the property/yard, and so on. Additionally, the system can receive refinements to specific products, e.g., a flow rate of a showerhead, and so on. In this way a user can provide information that more accurately describes the property to obtain more accurate cost reductions and utility usage reductions associated with the property improvement projects. Refinement information can include any information that can affect the utility use estimates or rebates associated with products, such as information altering utility usage, utility rates, utility usage tiers, property size, and so on.

The system receives refinement information (block 402). The user can access a user interface, e.g., provided by the system or an outside system, of a resource, e.g., a web page, and input refinement information. An example of a user interface to input refinement information is described below, with reference to FIG. 8F and FIG. 8J.

For instance, the user can identify a specific location of the property (e.g., if the user had not previously provided the specific location, as described above). The system can then obtain, e.g., from a property information database 202, information describing the property at the specific location. This can include, an accurate square footage of the property, a number of rooms, a number of bathrooms, size of the kitchen, whether it has a basement, type of yard, and so on. Additionally, the user can identify a number of occupants that will occupy the property, a thermostat setting for the property, e.g., a minimum and maximum temperature acceptable by the user, and whether the property will be occupied during the day. In some implementations, the user can provide other refinement information, such as specific products they own, or general or specific attributes of specific products which the system can use to determine utility usage of the products, e.g., as described below in FIG. 8J for a showerhead improvement project.

Furthermore, as described above, the system can access profile information for the specified property (e.g., information submitted by a property owner). The profile information can include particular systems, products, appliances, and so on, that are utilized in the specified property, along with actual property improvement projects that have been implemented.

The system modifies the utility use reductions and utility cost reductions for products associated with property improvement projects based on the refinement information (block 404). The system uses the refinement information to update the utility use estimates and utility cost estimates for products associated with the property improvement projects. Although refinement information is described herein as revising initial calculations performed on a representative form, the same refinement information can be directly used in initial calculations, in some embodiments, such as when a user specifies a particular property from the outset.

For instance, if the system utilized an assumption that three people were to occupy the property, and the refinement information identifies five, the system can increase the utility use estimates, e.g., greater frequency of showers and thus water/natural gas usage for a showerhead, usage of washing machines and thus greater water usage, toilet usage, and so on. Similarly, the system can obtain thermostat settings that the user intends to utilize, and update the utility use estimates for an electric or natural gas heater in regards to particular months and/or seasons. If the user prefers a warmer temperature than a temperature the system had utilized to initially determine utility use estimates, the system can determine that utility use estimates will be higher, e.g., in winter months, from the added cost of heating.

Additionally, the refinement information can identify a time of day that the user utilizes certain products, e.g., showerhead, washing machine, television, and so on. Since utility tier pricing can depend on demand experienced over the day, particular times might increase utility cost estimates even if the utility usage remains the same. The system can then update the utility cost estimates to factor in times utilities are being utilized.

In some embodiments, the refinement information can be automatically retrieved from records, for example from user-recorded utility readings, parsed from a utility website, or downloaded using a utility record API. For example, a user can provide login information to a utility website, and the system can automatically retrieve (for example using a Green Button or other API) electricity usage measurements by the day, hour, or other interval. Thus, the system can automatically determine at least some refinement information based on historical usage patterns. In this way, the system can determine utility usages according to empirically observed utility usages for a property, which can vary according to season. For instance, a particular property owner can prefer that during winter months, their property is kept at a temperature above an average temperature of other properties (e.g., the owner prefers a hot temperature). This seasonal information can be obtained from Green Button, or other information.

The system modifies the property improvement projects based on the refinement information (block 406). The system computes updated utility cost reductions and utility use reductions associated with each property improvement project, e.g., provided for presentation to the user, or for each potential property improvement project. After modifying the property improvement projects, the system can update an order the projects are presented in, e.g., highest cost savings or usage reduction provided first, or the system can swap a property improvement project out for a different property improvement project associated with highest cost savings or greatest usage reduction.

FIG. 5A is a flowchart of an example process for determining baseline utility usage estimates associated with a property. For convenience, the process 500 will be described as being performed by a system of one or more computers, e.g., the property improvement system 200.

In general, to determine utility use reduction estimates and utility cost reduction estimates, the system determines a baseline estimated utility usage for a property utilizing information describing the property (e.g., publicly available information), such as climate, square footage, lot size, year built, and default assumptions for space heating fuel, water heating fuel, presence of air conditioning, air conditioning type, and equipment efficiency.

However, if the system stores profile information associated with the property, or obtains (e.g., from refinement information entered by a user), actual product information associated with the property, or actual property improvement projects that have been implemented, the system modifies the above determined utility use estimates. For instance, the profile information can specify particular products, such as a particular refrigerator, and the system can access information associated with the utility usage by the products (e.g., ENERGY STAR information, such as a rating). Furthermore, the system can identify whether the property includes a swimming pool, rooftop photovoltaics, and can determine an installation year for heating and cooling equipment (e.g., the installation year can affect efficiency).

The system can then determine utility use savings and utility cost savings associated with a particular improvement project that is going to be implemented, which is described below with reference to FIG. 5B. For example, once the baseline utility use estimates are determined, the system can determine a utility usage savings that a particular property improvement project will bring about.

The system determines base electric utility use associated with the property (block 502). As described above, to determine utility cost and utility use savings, the system first establishes a baseline utility usage, and then compares the baseline to utility usage after implementation of a property improvement project.

The system determines an expected quantity of electricity, e.g., measured in kWh/month, that specific products will utilize in a time period, e.g., a month, a season, prior to implementation of the property improvement project. In this way, the system can obtain utility cost usage and utility cost estimates of the products if the user takes no action, e.g., as a baseline.

In some implementations, the system determines a total electricity utility usage before implementation of the property improvement project, e.g., described below. The system then determines electricity use savings of each product associated with the improvement project after implementation, and computes a total electricity use savings for the property improvement project. The system can then identify the savings off the total electric bill from each property improvement project, or all property improvement projects combined.

For instance, if the property includes a heater, the system can determine whether heaters in the property are electric based on property records, typical property conditions in that area, or user-provided data (e.g., profile information for the property). Upon a positive determination, the system computes an expected electricity usage for the heater. For example, the system computes:

$$\frac{kWh}{month} = A + B * ( Square footage of property ) + C * ( number of occupants ) * Year Built Factor$$

If the system stores information specific to the property (e.g., stored in a property profile), the system can instead utilize the specific information, and for instance the system can instead compute:

$$\frac{kWh}{month} = ( A + B * ( Square footage of property ) + C * ( number of occupants ) ) * Year Built Factor * \frac{Default Heater Efficiency Factor}{Custom Heater Efficiency Factor}$$

The constants A, B, C vary by climate information, and can be empirically determined, or determined by a machine learning model. The values A-C may be impacted by user-provided information regarding heating demand due to window efficiency and age, building envelope quality and age, and total home air leakage. The Default Heater Efficiency Factor can be, for instance, a product of a minimum regulatory or governmental efficiency standard (e.g., federal efficiency standard) for new heating equipment installed the year the home was built and (b) typical current heating duct efficiency (what % of heated air is delivered to conditioned space, rather than leaking into unconditioned space) for homes built that year. Similarly, the Custom Heater Efficiency Factor can be, for instance, a product of a (a) a minimum governmental or regulatory efficiency standard (e.g., federal efficiency standard) for new heating equipment installed the year the user specified the heater was replaced and (b) typical current heating duct efficiency for ducts installed/replaced/repaired the year the user specified the ducts were replaced/repaired. Duct efficiency typical values can be derived from industry-standard assumptions and current national or local (e.g., with respect to the property) building codes. Additionally, the Custom Electric Heater Efficiency Factor can be determined based on user-provided responses to questions about the age and type of existing heating equipment. These Custom efficiency and use factors can also be derived from industry and government publications describing standard efficiencies and typical energy/water usage for equipment and systems based on the year they were manufactured. In some cases, these standard efficiencies can be determined by federal guidelines, ENERGY STAR information, and so on. Additionally, custom efficiency can be determined from actual product information being utilized (e.g., the system can access information associated with a model SKU and obtain actual efficiency information). The Default and Custom Efficiency factors utilized elsewhere in this specification can be determined similarly (e.g., Custom AC Efficiency Factor is determined in conformance with Custom Heater Efficiency Factor).

If the property includes an electric hot water heater, the system can compute:

$$\frac{kWh}{month} = D + E * ( number of occupants )$$

If the system stores information specific to the property (e.g., stored in a property profile), the system can instead utilize the specific information, and for instance the system can instead compute:

$$\frac{kWh}{month} = ( D + E * ( number of occupants ) ) * \frac{Default Water Heater Efficiency Factor}{Custom Water Heater Efficiency Factor}$$

The values D and E may be impacted by user-provided information regarding hot water use for specific appliances and end-uses.

If the property includes an air conditioner, the system can compute an expected electricity usage. For example the system computes:

$$\frac{kWh}{month} = ( F + G * ( Square footage of property ) + H * ( number of occupants ) ) * Year Built Factor$$

If the system stores information specific to the property (e.g., stored in a property profile), the system can instead utilize the specific information, and for instance the system can instead compute:

$$\frac{kWh}{month} = ( ( F + G * ( Square footage of property ) + H * ( number of occupants ) ) * Year Built Factor ) * \frac{Default AC Efficiency Factor}{Custom AC Efficiency Factor}$$

The constants F, G, H vary by climate information, and can be empirically determined, or determined by a machine learning model. The values F-H may be impacted by user-provided information regarding cooling demand due to window efficiency and age, building envelope quality and age, and total home air leakage.

If the property includes a pool, e.g., an indoor or outdoor pool, the system can compute an expected electricity usage. Additionally the system can determine whether the pool is heated by electricity. For example the system computes:

$$\frac{kWh}{month} == I + J$$

If the system stores information specific to the property (e.g., stored in a property profile), the system can instead utilize the specific information, and for instance the system can instead compute:

$$\frac{kWh}{month} = I + J + ( Custom Use Factor - Default Use Factor )$$

The value of I can be an amount of electricity necessary to run the pool, e.g., lights, filters, and so on. The value of the constant J identifies an amount of electricity the property is expected to use on heating the pool, and can vary depending on whether the pool is an indoor or outdoor pool.

If the property includes a spa, e.g., an indoor or outdoor spa, the system can compute an expected electricity usage. Additionally the system can determine whether the spa is heated by electricity. For example the system computes:

$$\frac{kWh}{month} = K + L$$

If the system stores information specific to the property (e.g., stored in a property profile), the system can instead utilize the specific information, and for instance the system can instead compute:

$$\frac{kWh}{month} = K + L + ( Custom Use Factor - Default Use Factor )$$

The value of K can be an amount of electricity necessary to run the spa, e.g., lights, filters, and so on. The value of the constant L identifies an amount of electricity the space is expected to use, and can vary depending on whether the spa is an indoor or outdoor spa.

The system can determine the usage of electricity by other products likely to be included in the property. For instance the system can obtain information identifying wattage of products, e.g., from a product information database 207, and information identifying a frequency of use of the product, and determine the usage of each product. For instance, a television and dishwasher might be used every day, but a washing machine might be used less often, e.g., every 2 or 3 days.

That is, if the property includes a clothes washing machine, the system can compute:

$$\frac{kWh}{month} = Default kWh \text{/} load * ( \frac{Default LOADS}{DAY} ) * ( number of occupants ) * ( \frac{Days}{Month} )$$

If the system stores information specific to the property (e.g., stored in a property profile), the system can instead utilize the specific information, and for instance the system can instead compute:

$$\frac{kWh}{month} = Custom kWh \text{/} load * ( \frac{Custom LOADS}{DAY} ) * ( number of occupants ) * ( \frac{Days}{Month} )$$

If the property includes a clothes drying machine, the system can compute:

$$\frac{kWh}{month} = Default kWh \text{/} load * ( \frac{Default LOADS}{DAY} ) * ( number of occupants ) * ( \frac{Days}{Month} )$$

If the system stores information specific to the property (e.g., stored in a property profile), the system can instead utilize the specific information, and for instance the system can instead compute:

$$\frac{kWh}{month} = Custom kWh \text{/} load * ( \frac{Custom LOADS}{DAY} ) * ( number of occupants ) * ( \frac{Days}{Month} )$$

If the property includes a dishwashing machine, the system can compute:

$$\frac{kWh}{month} = Default kWh \text{/} load * ( \frac{Default LOADS}{DAY} ) * ( number of occupants ) * ( \frac{Days}{Month} )$$

If the system stores information specific to the property (e.g., stored in a property profile), the system can instead utilize the specific information, and for instance the system can instead compute:

$$\frac{kWh}{month} = Custom kWh \text{/} load * ( \frac{Custom LOADS}{DAY} ) * ( number of occupants ) * ( \frac{Days}{Month} )$$

If the property includes a refrigerator or freezer, the system can compute:

$$\frac{kWh}{month} = Default kWh \text{/} month$$

If the system stores information specific to the property (e.g., stored in a property profile), the system can instead utilize the specific information, and for instance the system can instead compute:

$$\frac{kWh}{month} = Custom kWh \text{/} month$$

Where the kWh/month for the refrigerator or freezer is determined by the age, size, door configuration, and ENERGY STAR status of the default, existing, and proposed appliance.

The system can determine a quantity of electricity that the property is expected to use on lighting. For instance the system computes:

$$\frac{kWh}{month} = N + O * ( Square footage of property ) + P * ( number of occupants )$$

If the system stores information specific to the property (e.g., stored in a property profile), the system can instead utilize the specific information, and for instance the system can instead compute:

$$\frac{kWh}{month} = ( N + O * ( Square footage of property ) + P * ( number of occupants ) ) * \frac{Custom Lighting Use Factor}{Default Lighting Use Factor}$$

The system can determine a quantity of electricity that the property is expected to gain from use of photovoltaics (e.g., solar power). For instance, if the property does not include photovoltaics, the system determines that the gain is zero, however if the property does include photovoltaics, the system can compute:

$$\frac{kWh}{month} = - Q \frac{kWh}{mo * kW} * Custom kW$$

Where Q is a factor determined by local latitude, longitude, and weather conditions, and kW is the standardized output of the rooftop solar system based on the system size and panel efficiency.

As described in FIG. 3, the system can utilize actual property information, or the system can utilize assumptions about properties. For instance, the system can utilize an assumption that the property will include three occupants, at least until receiving refinement information described in FIG. 4. Additionally, if the system cannot determine particular characteristics of a user selected property, e.g., whether the property includes a pool, the system can utilize expected characteristics for representative properties in the same area, e.g., if a majority of properties include a pool, the system will assume a pool is present. The assumptions about properties can be stored in one or more databases, e.g., the user information database 208 and/or the property information database 202. Such assumptions can be replaced and/or modified by refinement information as discussed above.

Additionally, the constants described above, e.g., constants A-Q, can be determined by the system empirically. That is, the system can obtain actual electricity usage costs for products in the area, and determine values of the constants that comport with the actual electricity usage. If the system cannot obtain actual electricity usage for each characteristic specifically, e.g., usage for a pool, the system can utilize machine learning techniques to identify a quantity of electricity for each characteristic. The system can then determine the constants.

In some implementations the constants A-Q can vary by climate information, e.g., the constants can be greater or smaller depending on the time of year, or region of the country. Thus, properties in different geographical regions can employ different constants. The system can obtain climate information, and store the constants, in one or more databases, e.g., the climate information database 206.

The system can also access weather prediction information when computing the constants, and can utilize weather prediction information when, for instance, determining utility usage over a season. For example, the system can obtain weather prediction information that indicates upcoming summer months are to be hotter than average summer months (e.g., hotter by a particular threshold). The system can modify constants that are affected by an increase in heat, for example, constants A-C(e.g., constants associated with heating the property), constants F-H (e.g., constants associated with cooling the property), and so on. In this way, the system can more accurately determine utility use estimates for upcoming months, seasons, and so on. Optionally, when presenting utility cost savings associated with implementing a property improvement project, the system can include information describing a predicted increase in utility usage due to a weather event as an incentive for the user to implement the project. In some implementations, the system can determine utility cost and use reductions utilizing (1) weather prediction information, and (2) average climate information. The system can then present information, for instance as described in step 306, that describes that due to upcoming weather, a particular property improvement project is temporarily better or worse (e.g., temporarily reduces utility usage more as compared to normal, or temporarily reduces utility usage less as compared to normal).

After determining a baseline utility use estimate, the system determines utility use estimates associated with property improvement projects being implemented, and determines utility use reductions once the property improvement projects are implemented, which is described below with reference to FIG. 5B

The system determines baseline natural gas usage associated with the property (block 504).

In some implementations, the system determines a total natural gas utility usage before implementation of the property improvement project, e.g., described below. The system then determines natural gas use savings of each product associated with the improvement project after implementation, and computes a total natural gas use savings for the property improvement project. The system can then identify the savings off the total natural gas bill from each property improvement project, or all property improvement projects combined.

The system determines an expected quantity of natural gas, e.g., measured in

$$\frac{therms}{month} ,$$

that specific products will Utilize in a time period, e.g., a month, prior to implementation of the property improvement project. In this way, the system can obtain utility cost usage and utility cost estimates of the products if the user takes no action, e.g., as a baseline.

If the property includes a space heater, the system can determine whether the space heater utilizes natural gas, e.g., based on property records, typical property conditions in that area, or user-provided data. Upon a positive determination, the system computes an expected quantity of natural gas. For instance, the system computes:

$$\frac{therms}{month} = A + B * ( Square footage of property ) + C * ( number of occupants ) * Year Built Factor$$

If the system stores information specific to the property (e.g., stored in a property profile), the system can instead utilize the specific information, and for instance the system can instead compute:

$$\frac{therms}{month} = ( A + B * ( Square footage of property ) + C * ( number of occupants ) ) * Year Built Factor * \frac{Default Heater Efficiency Factor}{Custom Heater Efficiency Factor}$$

The constants A, B, C vary by climate information, and can be empirically determined, or determined by a machine learning model. The values A-C may be impacted by user-provided information regarding heating demand due to window efficiency and age, building envelope quality and age, and total home air leakage.

If the property includes a water heater that utilizes natural gas, e.g., based on property records, typical property conditions in that area, or user-provided data, the system can compute an expected quantity of natural gas. For instance, the system computes:

$$\frac{therms}{month} = D + E * ( number of occupants )$$

If the system stores information specific to the property (e.g., stored in a property profile), the system can instead utilize the specific information, and for instance the system can instead compute:

$$\frac{therms}{month} = ( D + E * ( number of occupants ) ) * \frac{Default Water Heater Efficiency Factor}{Custom Water Heater Efficiency Factor}$$

The constants D and E may be impacted by user-provided information regarding hot water use for specific appliances and end-uses

If the property includes a pool, the system can compute an expected quantity of natural gas (e.g., due to heating the pool). For instance, the system computes:

$$\frac{therms}{month} = F$$

If the system stores information specific to the property (e.g., stored in a property profile), the system can instead utilize the specific information, and for instance the system can instead compute:

$$\frac{therms}{month} = F + ( Custom Use Factor - Default Use Factor )$$

The value of the constant F can vary depending on whether the pool is an indoor or outdoor pool, and the magnitude of heating required for a specific month for that climate.

The system can determine whether the property includes a spa, and if so whether the spa is heated by natural gas. Upon a positive determination, the system computes an expected quantity of natural gas. For instance, the system computes:

$$\frac{therms}{month} = G$$

If the system stores information specific to the property (e.g., stored in a property profile), the system can instead utilize the specific information, and for instance the system can instead compute:

$$\frac{therms}{month} = G + ( Custom Use Factor - Default Use Factor )$$

The value of the constant G can vary depending on whether the spa is an indoor or outdoor spa, and the magnitude of heating required for a specific month for that climate.

The system can determine the usage of natural gas by other products likely to

$$\frac{therms}{month}$$

be included in a property. For instance the system can obtain information icientitying of products, e.g., from a product information database 207, and information identifying a frequency of use of the product, and determine the usage of each product.

If the property includes a clothes drying machine, the system can compute:

$$\frac{therms}{month} = Default therms \text{/} load * ( \frac{Default LOADS}{DAY} ) * ( number of occupants ) * ( \frac{Days}{Month} )$$

If the system stores information specific to the property (e.g., stored in a property profile), the system can instead utilize the specific information, and for instance the system can instead compute:

$$\frac{therms}{month} = Default therms \text{/} load * ( \frac{Custom LOADS}{DAY} ) * ( number of occupants ) * ( \frac{Days}{Month} )$$

As described above in block 502, the values of the constants can be determined empirically or with machine learning techniques. Additionally, the values of the constants A-G can vary by climate information, and/or weather prediction information, associated with an area of the property. For instance, for a property located in a cold area, the quantity of natural gas used to heat a pool in a particular month can be greater than a property located in a warm area.

After determining baseline utility use estimates for the property, the system determines utility use estimates associated with one or more property improvement projects being implemented, which is described below with reference to FIG. 5B.

The system determines baseline water utility usage associated with the property (block 506).

The system determines a total water utility usage before implementation of the property improvement project. The system then determines water use savings of each product associated with the improvement project after implementation, and computes a total water use savings for the property improvement project (e.g., described below, with respect to FIG. 5B). The system can then identify the savings off the total water bill from each property improvement project, or all property improvement projects combined.

The system therefore determines water usage of specific products associated with the property.

The system determines an expected quantity of water, e.g., measured in gallons/month, that the specific products will utilize in a time period, e.g., a month, prior to implementation of the property improvement project. In this way, the system can obtain utility cost usage and utility cost estimates of the products if the user takes no action, e.g., as a baseline.

If the property includes a toilet, the system can compute an expected quantity of water. For instance, the system computes:

$$\frac{gallons}{month} = ( Default Flush rate ) * ( \frac{Default \# Flushes}{Day} ) * ( Number of occupants ) * ( \frac{Days}{Month} )$$

If the system stores information specific to the property (e.g., stored in a property profile), the system can instead utilize the specific information, and for instance the system can instead computes:

$$\frac{gallons}{month} = ( Custom Flush rate ) * ( \frac{Custom \# Flushes}{Day} ) * ( Number of occupants ) * ( \frac{Days}{Month} )$$

The system can determine the flush rate by determining whether the property was built before, or after, a threshold date, e.g., 1985, 1990, 1992, e.g., based on property records.

For properties built after the threshold date, the system computes each flush as utilizing a particular quantity of water, e.g., 1.3 gallons, 1.6 gallons, 2 gallons. For properties built prior to the threshold date, the system computes each flush as utilizing a different amount of water, e.g., 2.3 gallons, 2.5 gallons, 3.1 gallons.

If the property includes a shower, the system can compute an expected quantity of water. For instance, the system computes:

$$\frac{gallons}{month} = ( Default Flow rate ) * ( \frac{Default Showerhead Minutes}{Day * Person} ) * ( Number of occupants ) * ( \frac{Days}{Month} )$$

If the system stores information specific to the property (e.g., stored in a property profile), the system can instead utilize the specific information, and for instance the system can instead computes:

$$\frac{gallons}{month} = ( Custom Flow rate ) * ( \frac{Custom Showerhead Minutes}{Day * Person} ) * ( Number of occupants ) * ( \frac{Days}{Month} )$$

If the property includes a kitchen faucet, the system can compute an expected quantity of water. For instance, the system computes:

$$\frac{gallons}{month} = ( Default Flow rate ) * ( \frac{Default Faucet Minutes}{Day * Person} ) * ( Number of occupants ) * ( \frac{Days}{Month} )$$

If the system stores information specific to the property (e.g., stored in a property profile), the system can instead utilize the specific information, and for instance the system can instead computes:

$$\frac{gallons}{month} = ( Custom Flow rate ) * ( \frac{Custom Faucet Minutes}{Day * Person} ) * ( Number of occupants ) * ( \frac{Days}{Month} )$$

If the property includes a bathroom faucet, the system can compute an expected quantity of water. For instance, the system computes:

$$\frac{gallons}{month} = ( Default Flow rate ) * ( \frac{Default Faucet Minutes}{Day * Person} ) * ( Number of occupants ) * ( \frac{Days}{Month} )$$

If the system stores information specific to the property (e.g., stored in a property profile), the system can instead utilize the specific information, and for instance the system can instead computes:

$$\frac{gallons}{month} = ( Custom Flow rate ) * ( \frac{Custom FaucetMinutes}{Day * Person} ) * ( Number of occupants ) * ( \frac{Days}{Month} )$$

If the property includes a dishwasher, the system can compute an expected quantity of water. For instance, the system computes:

$$\frac{gallons}{month} = ( \frac{Default gallons}{load} ) * ( \frac{Default \# Loads}{Day * Person} ) * ( Number of occupants ) * ( \frac{Days}{Month} )$$

If the system stores information specific to the property (e.g., stored in a property profile), the system can instead utilize the specific information, and for instance the system can instead computes:

$$\frac{gallons}{month} = ( \frac{Custom gallons}{load} ) * ( \frac{Custom \# Loads}{Day * Person} ) * ( Number of occupants ) * ( \frac{Days}{Month} )$$

If the property includes a clothes washer, the system can compute an expected quantity of water. For instance, the system computes:

$$\frac{gallons}{month} = ( \frac{Default gallons}{load} ) * ( \frac{Default \# Loads}{Day * Person} ) * ( Number of occupants ) * ( \frac{Days}{Month} )$$

If the system stores information specific to the property (e.g., stored in a property profile), the system can instead utilize the specific information, and for instance the system can instead computes:

$$\frac{gallons}{month} = ( \frac{Custom gallons}{load} ) * ( \frac{Custom \# Loads}{Day * Person} ) * ( Number of occupants ) * ( \frac{Days}{Month} )$$

If the property includes outside products, e.g., grass, the system can compute an expected water usage to maintain the outside products. This quantity can be used to recommend a property improvement project related to replacing grass with other plants, e.g., cacti. For instance, the system computes:

$$\frac{CCF}{month} = C * ( lawn size )$$

The value of constant C, is computed by the system, and can be a Theoretical Irrigation Requirement (TR), which can be computed from:

C=(Monthly Reference Evapotranspiration)−Lesser of [(0.25*Monthly reference Evapotranspiration) or (0.75*Monthly Effective Precipitation)]

If the monthly precipitation is less than 0.25 inches, then the monthly effective precipitation is zero. The value of C can, in some implementations, vary by climate. Additionally, the value of C can vary according to weather prediction information, for instance an upcoming season that is particularly rainy with respect to normal conditions (e.g., an El Nino year) can require less water for the grass.

If the system stores information specific to the property (e.g., stored in a property profile), the system can instead utilize the specific information, and for instance the system can instead computes:

$$\frac{CCF}{month} = C * ( lawn size ) * Custom Irrigation Use Factor$$

After determining baseline water utility usage, the system determines utility use estimates and utility cost estimates associated with the property improvement projects, which is described in more detail below, with reference to FIG. 5B.

FIG. 5B illustrates an example process 550 for determining utility use reduction estimates and utility cost reduction estimates associated with property improvement projects. For convenience, the process 550 will be described as being performed by a system of one or more computers (e.g., the property improvement system 200).

The system determines electric utility use reduction estimates and electric utility cost reduction estimates for one or more property improvement projects (block 552). As described above, the system can determine baseline utility usage for the property. To determine a reduction in utility usage after a property improvement project is implemented, the system can modify the baseline utility usage according to an effect that a property improvement project has.

For instance, if a property improvement project is associated with an electric heater, the system computes an expected electricity usage for the property improvement project. For example, the system computes:

$$\frac{kWh}{month} = ( A + B * ( Square footage of property ) + C * ( number of occupants ) ) * Year Built factor * \frac{Custom Heater Efficiency Factor}{Proposed Heater Efficiency Factor}$$

Proposed heater efficiency factor, and other subsequent proposed efficiencies factors, can be a product of (a) current ENERGY STAR requirements for qualifying heaters, or other subsequent products, and (b) typical required duct efficiency, or other typical requirements, for newly-installed or repaired ducts, or other products related to subsequent products. In some implementations, actual efficiency information associated with a particular product can be utilized. Duct efficiency typical values can be derived from industry-standard assumptions and current national or local (e.g., with respect to the property) building codes.

If a property improvement project is associated with an electric hot water heater, the system can compute:

$$\frac{kWh}{month} = ( D + E * ( number of occupants ) ) * \frac{Custom Water Heater Efficiency Factor}{Proposed Water Heater Efficiency Factor}$$

If the property improvement project is associated with an air conditioner, the system can compute an expected electricity usage of the new air conditioner. For example, the system computes:

$$\frac{kWh}{month} = ( ( F + G * ( Square footage of proptery ) + H * ( number of occupants ) ) * Year Built Factor ) * \frac{Custom A C Efficiency Factor}{Proposed A C Efficiency Factor}$$

If a property improvement project is associated with a pool, e.g., an indoor or outdoor pool, the system can compute:

$$\frac{kWh}{month} = I + J + ( Proposed Use Factor - Custom Use Factor )$$

If a property improvement project is associated with a spa, e.g., an indoor or outdoor spa, the system can compute:

$$\frac{kWh}{month} = K + L + ( Proposed Use Factor - Custom Use Factor )$$

The value of K can be an amount of electricity necessary to run the spa, e.g., lights, filters, and so on. The value of the constant L identifies an amount of electricity the space is expected to use, and can vary depending on whether the spa is an indoor or outdoor spa.

If the property improvement project is associated with a clothes washing machine, the system can compute:

$$\frac{kWh}{month} = Proposed \frac{kWh}{load} * ( \frac{Custom LOADS}{DAY} ) * ( number of occupants ) * ( \frac{Days}{Month} )$$

If the property improvement project is associated with a clothes drying machine, the system can compute:

$$\frac{kWh}{month} = Proposed \frac{kWh}{load} * ( \frac{Custom LOADS}{DAY} ) * ( number of occupants ) * ( \frac{Days}{Month} )$$

If the property improvement project is associated with a dishwashing machine, the system can compute:

$$\frac{kWh}{month} = Proposed \frac{kWh}{load} * ( \frac{Custom LOADS}{DAY} ) * ( number of occupants ) * ( \frac{Days}{Month} )$$

If the property improvement project is associated with a refrigerator or freezer, the system can compute:

$$\frac{kWh}{month} = Proposed kWh / month$$

Where, as described above, the kWh/month for the refrigerator or freezer is determined by the age, size, door configuration, and ENERGY STAR status of the default, existing, and proposed appliance.

If a property improvement project is associated with lighting, the system can determine a quantity of electricity that the property is expected to use on lighting. For instance the system computes:

$$\frac{kWh}{month} = ( N + O * ( Square footage of property ) + P * ( number of occupants ) ) * \frac{Proposed Lighting Use Factor}{Custom Lighting Use Factor}$$

If the property improvement project is associated with installing photovoltaics, the system computes:

$$\frac{kWh}{month} = - Q \frac{kWh}{mo * kW} * Proposed kW$$

For each property improvement project that a user is to implement, the system determines an effect that the property improvement project has on the determined baseline (e.g., determined in step 502). For example, if a property improvement project is associated with upgrading a water heater, the system determines a utility usage savings after the upgraded water heater is installed, and subtracts the utility usage savings from the determined baseline to determine utility usage after the property improvement project is implemented. That is, the system can obtain the information determined in FIG. 5A, such as utility usage of a water heater (e.g., described in step 502), and can compare the utility usage to a determined utility usage of an upgraded hot water heater (e.g., determined in step 552), to determine a utility usage reduction that is associated with the a water heater property improvement project. The system therefore determines an overall utility usage reduction by summing the utility use savings caused by each property improvement project.

However, a property improvement project that does not swap out a product for an upgraded product, but instead adds an entirely new product, can increase utility usage. For instance, a property improvement project associated with modifying a natural gas water heater to an electric water heater will increase the electricity usage, while also decreasing the natural gas usage.

The system then obtains information identifying electricity utility rates for an area that includes the property (e.g., utility rates by usage tier and month, season, and so on). The system computes expected electricity cost estimates for the baseline utility usage (e.g., described in FIG. 5A), and determines expected electricity cost estimates after the property improvement projects are implemented. The difference between them represents the utility cost reduction estimate.

The system determines natural gas utility use reduction estimates and natural gas utility cost reduction estimates for one or more property improvement projects (block 554). As described above, the system can determine baseline utility usage for the property. To determine a reduction in utility usage after a property improvement project is implemented, the system can modify the baseline utility usage according to an effect that a property improvement project has.

If the property improvement project is associated with a space heater that uses natural gas, the system computes an expected quantity of natural gas. For instance, the system computes:

$$\frac{therms}{month} = ( A + B * ( Square footage of property ) + C * ( number of occupants ) ) * YearBuilt factor * \frac{Custom Heater Efficiency Factor}{Proposed Heater Efficiency Factor}$$

If the property improvement project is associated with a water heater that utilizes natural gas, the system can compute an expected quantity of natural gas. For instance, the system computes:

$$\frac{therms}{month} = ( D + E * ( number of occupants ) ) * \frac{Custom Water Heater Efficiency Factor}{Proposed Water Heater Efficiency Factor}$$

If the property improvement project is associated with a pool, e.g., upgrading a heating element, the system can compute an expected quantity of natural gas. For instance, the system computes:

$$\frac{therms}{month} = F + ( Proposed Use Factor - Custom Use Factor )$$

If the property improvement project is associated with a spa, the system computes an expected quantity of natural gas. For instance, the system computes:

$$\frac{therms}{month} = G + ( Proposed Use Factor - Custom Use Factor )$$

If the property improvement project is associated with a clothes drying machine, the system can compute:

$$\frac{therms}{month} = Proposed therms \text{/} load * ( \frac{Custom LOADS}{DAY} ) * ( number of occupants ) * ( \frac{Days}{Month} )$$

As described above, for each property improvement project that a user is to implement, the system determines an effect that the property improvement project has on the determined baseline (e.g., determined in step 504). For example, if a property improvement project is associated with upgrading a clothes drying machine, the system determines a utility usage savings after the upgraded clothes drying machine is installed, and subtracts the utility usage savings from the determined baseline to determine utility usage after the property improvement project is implemented. That is, the system can obtain the information determined in FIG. 5A, such as utility usage of a clothes drying machine (e.g., described in step 504), and can compare the utility usage to a determined utility usage of an upgraded clothes drying machine (e.g., determined in present step 554), to determine a utility usage reduction that is associated with a clothes dryer property improvement project. The system therefore determines an overall utility usage reduction by summing the utility use savings caused by each property improvement project.

However, a property improvement project that does not swap out a product for an upgraded product, but instead adds an entirely new product, can increase utility usage. For instance, a property improvement project associated with modifying an electric water heater to be a natural gas heater will increase the natural gas usage, while also decreasing the electricity usage.

The system then obtains information identifying natural gas utility rates for an area that includes the property (e.g., utility rates by usage tier and month, season, and so on). The system computes expected natural gas cost estimates for the baseline utility usage (e.g., described in FIG. 5A), and determines expected natural gas cost estimates after the property improvement projects are implemented. The difference between them represents the utility cost reduction estimate.

The system determines water utility use reduction estimates and water utility cost reduction estimates for one or more property improvement projects (block 556). As described above, the system can determine baseline utility usage for the property. To determine a reduction in utility usage after a property improvement project is implemented, the system can modify the baseline utility usage according to an effect that a property improvement project has.

If a property improvement project is associated with a toilet, the system can compute an expected quantity of water. For instance, the system computes:

$$\frac{gallons}{month} = ( Proposed Flush rate ) * ( \frac{Proposed \# Flushes}{Day} ) * ( Number of occupants ) * ( \frac{Days}{Month} )$$

If the property improvement project is associated with a shower, the system can compute an expected quantity of water. For instance, the system computes:

$$\frac{gallons}{month} = ( Proposed Flow rate ) * ( \frac{Custom ShowerheadMinutes}{Day * Person} ) * ( Number of occupants ) * ( \frac{Days}{Month} )$$

If the property improvement project is associated with a kitchen faucet, the system can compute an expected quantity of water. For instance, the system computes:

$$\frac{gallons}{month} = ( Proposed Flow rate ) * ( \frac{Custom FaucetMinutes}{Day * Person} ) * ( Number of occupants ) * ( \frac{Days}{Month} )$$

If the property improvement project is associated with a bathroom faucet, the system can compute an expected quantity of water. For instance, the system computes:

$$\frac{gallons}{month} = ( Proposed Flow rate ) * ( \frac{Custom FaucetMinutes}{Day * Person} ) * ( Number of occupants ) * ( \frac{Days}{Month} )$$

If the property improvement project is associated with a dishwasher, the system can compute an expected quantity of water. For instance, the system computes:

$$\frac{gallons}{month} = ( \frac{Proposed gallons}{load} ) * ( \frac{Custom \# Loads}{Day * Person} ) * ( Number of occupants ) * ( \frac{Days}{Month} )$$

If the property improvement project is associated with a clothes washer, the system can compute an expected quantity of water. For instance, the system computes:

$$\frac{gallons}{month} = ( \frac{Proposed gallons}{load} ) * ( \frac{Custom \# Loads}{Day * Person} ) * ( Number of occupants ) * ( \frac{Days}{Month} )$$

If the property improvement project is associated with outside products, e.g., grass, the system can compute an expected water usage to maintain the outside products. This quantity can be used to recommend a property improvement project related to replacing grass with other plants, e.g., cacti. For instance, the system computes:

$$\frac{CCF}{month} = C * ( lawn size ) * Proposed Irrigation Use Factor$$

Similar to the above, for each property improvement project that a user is to implement, the system determines an effect that the property improvement project has on the determined baseline (e.g., determined in step 506). For example, if a property improvement project is associated with upgrading a toilet, the system determines a utility usage savings after the upgraded toilet is installed, and subtracts the utility usage savings from the determined baseline to determine utility usage after the property improvement project is implemented. That is, the system can obtain the information determined in FIG. 5A, such as utility usage of a toilet (e.g., described in step 506), and can compare the utility usage to a determined utility usage of an upgraded toilet (e.g., determined in present step 556), to determine a utility usage reduction that is associated with a toilet. The system therefore determines an overall utility usage reduction by summing the utility use savings caused by each property improvement project.

The system then obtains information identifying water utility rates for an area that includes the property (e.g., utility rates by usage tier and month, season, and so on). The system computes expected water cost estimates for the baseline utility usage (e.g., described in FIG. 5A), and determines expected water cost estimates after the property improvement projects are implemented. The difference between them represents the utility cost reduction estimate.

The system determines sewer utility use reduction estimates and sewer utility cost reduction estimates for one or more property improvement projects (block 558). In some implementations, the system determines a total sewer utility usage before implementation of the property improvement project, e.g., determines a baseline as described above. The system can assume that the total sewer utility usage is proportional to the water baseline determined in block 506. The system then determines sewer use savings of each product associated with the improvement project after implementation, and computes a total sewer use savings for the property improvement project. The system can then identify the savings off the total sewer bill from each property improvement project, or all property improvement projects combined. To determine utility use reduction estimates and utility cost reduction estimates, the system determines that the utility use reductions will be proportional to water use reductions determined above. The system can then obtain sewer utility rates, and determine cost reductions based on the sewer utility rates and sewer utility reductions.

FIG. 6 is a flowchart of an example process 600 for generating documents identifying property improvement projects associated with a professional. For convenience, the process 600 will be described as being performed by a system of one or more computers, e.g., the property improvement system 200.

The system receives login information from a user device (block 602). In some implementations, the system can maintain user information associated with particular users, e.g., professionals, who in some implementations can pay a fee to access the system. For instance, a particular professional, e.g., a contractor, might want to access the system to identify properties that can utilize his/her services. The professional can then provide marketing materials of his/her services to the identified properties. The system thus receives login information, e.g., username, password, and authenticates the login information to provide access to the system.

The system obtains information identifying an area a professional is interested in (block 604). The professional can provide an area, e.g., a city, a zip code, a metropolitan region, which the professional operates in, e.g., is licensed to operate in, or is within a distance from his/her workplace.

The system determines properties determined to benefit from particular property improvement projects associated with the professional. For instance, the system can identify particular properties that have been determined to benefit from a landscaping property improvement project, e.g., to remove a large lawn in an area with high water rates. Determining property improvement projects for properties is described above, with reference to FIG. 3. In an embodiment, the system can estimate savings for a particular project on a plurality of properties in the defined area, and can generate a list of properties that have projected savings (or ROI or payback period) greater than a threshold.

The system can provide information identifying one or more of the determined properties to the professional and receives selections of one or more properties in the area (block 606). The professional can select one or more of the properties that interest him/her.

The system generates documents identifying property improvement projects for each selected property (block 608). The professional's user information can maintain information identifying the professional, and information related to the generating of documents, e.g., marketing materials, to be provided to potential customers. For instance, the system can maintain a logo associated with the professional, preferred formatting information, and so on.

The system then generates a document for each selected property that identifies property improvement projects determined to be of use to the respective property owner, e.g., lower utility usage or utility costs. In some implementations, the document can include expected utility cost reductions, expected utility usage reductions, and/or rebates associated with products involved in the property improvement projects.

In some implementations, a realtor can utilize the above description to provide information identifying products or property improvement projects that are determined to be benefit potential purchases of a property.

FIG. 7 is a flowchart of an example process for providing information to a retailer identifying rebates, or property improvement projects, associated with products they sell. For convenience, the process 700 will be described as being performed by a system of one or more computers, e.g., the property improvement system 200.

The system receives one or more identifications of products sold by a retailer (block 702). A retailer, e.g., a brick and mortar retailer, an online retailer, can provide identifications of products, e.g., SKU numbers, names of products, which the retailer sells. In some implementations, the system can receive the identifications by implementing an application programming interface (API) that identifies specific calls, e.g., received by an outside system, the system can interpret. For instance, a retailer can utilize an API call to provide identifications of products they sell.

The system obtains information identifying rebates associated with the products (block 704). The system receives the identifiers, and matches the identifiers to stored products, or product types, in one or more databases, e.g., the product information database 207, the utility/government information database 204. For instance, the system can receive a specific identifier of a washing machine, and access the databases to determine whether rebate information associated with washing machines exists.

The system therefore obtains rebate information associated with the received products, or product types associated with the products.

The system obtains information identifying property improvement projects associated with the receive products (block 706). The system determines, from the types of products received, any property improvement projects that include the type of products. In some implementations, the system can identify property improvement projects that include more than a threshold number of received products, e.g., 3, 5, 8.

The system provides information to the retailer identifying the rebates (block 708).

After obtaining rebates associated with products, and property improvement projects that utilize the received products, or types of received products, the system provides the obtained information to the retailer. In some implementations, the system can generate documents, e.g., flyers, documents to place near the physical product, an electronic image or portion of a website, that identify one or more of, the retailer, the product, or rebates.

Example User Interfaces

FIG. 8A is an illustration of an example user interface for property improvement projects. The user interface includes an identification of a website associated with providing property improvement projects, e.g., “WaterGenius.” Additionally, the user interface of FIG. 8A includes a selectable option for a user of the user interface to identify an area. In the user interface, a user has selected “Mountain View, Calif.”, additionally the interface illustrates that “City of Mountain View Public Works” is a utility company. Optionally, though not illustrated, a user can provide a particular address.

In this way a user of the user interface can provide information identifying an area he/she is interested in, e.g., described above with reference to block 302 of FIG. 3.

FIG. 8B is an illustration of an example user interface identifying total utility cost savings from various property improvement projects. The illustration shows the total savings, e.g., “$430 per year” along with the projects “Landscape, Toilet, Showerhead, Kitchen Faucet, Bathroom Faucet, Dishwasher, Clothes Washer.” Additionally the illustration includes a community savings target, e.g., a general target identified for the region.

FIG. 8C is an illustration of an example user interface identifying a particular property improvement project. The user interface includes an identification of a particular property improvement project, e.g., “Landscape” with associated information identifying a total utility cost savings, e.g., “$278 per year.” when the cost of the project is factored in. Additionally, the user interface includes an identification of total rebates, e.g., “$2/sq ft for lawn replacement”, and “$5,340”, along with a total estimated cost of the project, e.g., “$3-$12/sq ft.”

The user interface includes a total estimated rebate for the property, which is based on the square footage of the particular property entered by the user, or a representative property for the region.

Additionally, the illustration includes four tabs related to the property improvement project, e.g., “Landscape Savings.” The tabs include, Overview, which is presently displayed, Product Picks, e.g., illustrated in FIG. 8D, Find a Pro, e.g., illustrated in FIG. 8E, Refine Savings, e.g., illustrated in FIG. 8F.

FIG. 8D is an illustration of an example user interface identifying a recommended product for a property improvement project. The user interface includes an identification of a property improvement project, e.g., “Landscape Savings,” and recommended products. The illustration includes an identification of potential products, e.g., Low Water Landscape, Very Low Water Landscape, and Extremely Low Water Landscape. Each product includes an explanation of benefits.

FIG. 8E is an illustration of an example user interface identifying professionals that can implement a property improvement project. The user interface includes an identification of a property improvement project, e.g., “Landscape Savings,” and professionals that can implement the property improvement project. As described above, in some implementations only professionals with user submitted, or professionally determined, ratings greater than a threshold are included.

FIG. 8F is an illustration of an example user interface identifying refinement information. The user interface includes an identification of the property improvement project described above, e.g., “Landscape Savings.” In the user interface, options to refine specific information relevant to the property improvement project are displayed, including “Landscape Size” and “Lawn Type.”

FIG. 8G is an illustration of a user interface identifying an overview of another property improvement project, e.g., “Showerhead Savings.” The illustration identifies a utility savings per year, e.g., “$30/year” and rebate information if a user purchases a recommended product, e.g., a free showerhead if the user is replacing a showerhead that uses 2.5 Gallons/Minute.

FIG. 8H is an illustration of a user interface identifying product picks. The illustration includes filters of product picks that a user can select. For instance, the user can refine the product picks by price, brand, color, number of spray settings, spray patterns, and so on. Additionally, the illustration includes product picks with associated ratings, e.g., user-inputted ratings or professional ratings, along with price comparisons at one or more retailers.

FIG. 8I is an illustration of a user interface identifying professionals that can implement the improvement project.

FIG. 8J is an illustration of a user interface identifying refinement options related to the improvement project. In some implementations, refinement information can depend on the particular property improvement project, e.g., refinements related to the improvement project. Therefore, the illustration of FIG. 8J includes refinement options related to “Showerhead Savings,” including, number of showerheads, number of people live in the property, number of current showerheads, average length of showers, and flow rate of showerheads.

FIG. 8K is an illustration of a toilet savings property improvement project.

FIG. 8L is an illustration of a kitchen faucet property improvement project.

FIG. 8M is an illustration of a bathroom faucet savings property improvement project.

FIG. 8N is an illustration of a dishwasher savings property improvement project.

FIG. 8O is an illustration of a clothes washer savings property improvement project. The illustration includes rebate information identifying that a user can receive $150 if he/she installs a washer listed in the “ENERGY STAR most efficient list of 2015”.

FIG. 8P illustrates an example user interface 850 for presenting summary information associated with property improvement projects 860. The user interface 850 specifies a particular address 852 that a user of the user interface 850 provided, along with information describing the property 852 (e.g., information obtained from one or more commercial databases, or information entered by the user).

The user interface includes a score 856 associated with a present utility usage of the property 852. For instance, the score can be determined, as described in FIG. 5A, from determining a baseline utility usage of the property and comparing the baseline utility usage to other properties (e.g., properties in a same geographic area, a same neighborhood, within a threshold distance, and so on). The system can utilize default information for products when determining a baseline, or if the system stores actual product information for other properties, can determine a baseline for the other properties using the stored information. The other properties can, in some implementations, be properties associated with similar features (e.g., size of the property, footprint, number of bedrooms, and so on). Additionally, the system can determine a property with average characteristics (e.g., a representative property as described above), and can determine a baseline utility usage of the average property. The baseline utility usage, and baseline utility usages of other properties, can be normalized, and the score 856 can be determined for the property 852. Examples of determining a score 856 are described, for instance, in U.S. patent application Ser. No. 15/074,734, titled “Utility Monitoring and Database Correlation System, Including User Interface Generation for Utility Assessment,” which is hereby incorporated by reference in its entirety for all purposes.

Additionally, the system has identified loans for the property improvement projects 860 presented in the user interface 850. As described above, lenders can be incentivized to lend money to an application if the lender has access to utility cost savings associated with implementing a property improvement project (e.g., the applicant will have lesser bills, and thus more money). Similarly, as described above, the system can identify professionals that can implement any of the presented property improvement projects 859.

The user interface 850 further enables a user to specify 862 actual product, property improvement information, and/or information about the property 852, which the system can receive and store (e.g., property profile information). The user can filter a total amount of property improvement projects (e.g., the user has selected that he/she is interested in “Solar,” but not interested in “Washer/Dryer.”). If the system stores profile information about the property 852, the system can identify property improvement projects that the user has already implemented (e.g., the system can determine that the user has upgraded a washer/dryer within a threshold period of time).

The presented property improvement projects 860 include information describing each project, such as a title (e.g., “Windows”), estimated costs of implementing the project (e.g., as described above), estimated cost reduction estimates (e.g., as described above), an increase in the property's 852 value that would be attributable to the property improvement project, rebate information, and so on).

Each property improvement project includes a score adjacent to the property improvement project, which can represent an updated score 856 once the property improvement project is implemented. To determine the score, the system can determine an effect the property improvement project would have on utility use estimates (e.g., as described in FIG. 5B). The system can then determine an updated score (e.g., from comparisons with other properties as described above). In this way, the user can determine that a “Solar” property improvement project would most increase the score (e.g., 75), and can weigh the increase against an estimated cost, savings information, home value increase, rebate information, and so on.

Each of the processes, methods, and algorithms described in the preceding sections may be embodied in, and fully or partially automated by, code modules executed by one or more computer systems or computer processors comprising computer hardware. The code modules (or “engines”) may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

In general, the terms “engine” and “module”, as used herein, refer to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the risk assessment system 200, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While certain example embodiments have been described, these embodiments have been presented by way of example only, and are not intended to limit the scope of the disclosure. Thus, nothing in the foregoing description is intended to imply that any particular element, feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method comprising:
by a system of one or more computers,
obtaining information describing property associated with a geographical area;
determining, using the information describing the property, one or more utility use estimates for products associated with a plurality of property improvement projects as applied to the property;
determining one or more property improvement projects to provide for presentation, from the plurality of property improvement projects, based on the utility use estimates; and
providing the one or more property improvement projects for presentation.

2. The method of claim 1, wherein providing property improvement projects for presentation comprises:
providing information describing each property improvement project, wherein information comprises costs associated with each property improvement project.

3. The method of claim 1, wherein providing property improvement projects includes providing a cost savings for each property improvement project over a selectable or preselected period of time.

4. The method of claim 3, further comprising:
receiving refinement information, wherein the refinement information includes specific identifiers of particular products, wherein the property improvement projects are determined using estimated characteristics of the particular products; and
modifying the cost savings associated with one or more property improvement projects based on actual characteristics of the particular products.

5. The method of claim 1, wherein obtaining information describing a property comprises receiving, from a contractor, a specific address of a property owner, and wherein the one or more property improvement projects are a property improvement project to be implemented by the contractor, and wherein providing the property improvement project for presentation comprises:
providing costs, received from the contractor, associated with implementing the property improvement project, and providing utility cost savings after the property improvement project is implemented.

6. The method of claim 1, wherein obtaining information describing a property comprises:
receiving a particular address associated with the property, wherein information describing the property includes characteristics of the property, or
receiving an identification of the area, and determining a representative property associated with average characteristics of properties in the area, wherein information describing the representative property includes the average characteristics.

7. The method of claim 1, wherein providing a particular property improvement project for presentation comprises:
determining an expected increase in a value associated with the property that can be attributed to implementing the particular property improvement project; and
providing information describing the particular property improvement project, including costs savings associated with the particular property improvement project and the expected increase in the value associated with the property.

8. The method of claim 1, wherein providing property improvement projects comprises:
accessing one or more databases storing information associated with products; and
providing, for each property improvement project using the stored information, information identifying utility cost savings and costs to implement the project with different price tiers of products associated with the property improvement project, each price tier associated with a respective utility cost savings.

9. A non-transitory computer storage medium storing instructions that when executed by a system of one or more computers, causes the system to perform operations comprising:
obtaining information describing property associated with a geographical area;
determining, using the information describing the property, one or more utility use estimates for products associated with a plurality of property improvement projects as applied to the property;
determining one or more property improvement projects to provide for presentation, from the plurality of property improvement projects, based on the utility use estimates; and
providing the one or more property improvement projects for presentation.

10. The non-transitory computer storage medium of claim 9, wherein providing property improvement projects for presentation comprises:
providing information identifying each property improvement project, wherein information comprises costs associated with each property improvement project.

11. The non-transitory computer storage medium of claim 8, wherein providing property improvement projects includes providing a cost savings for each property improvement project over a selectable or preselected period of time.

12. The non-transitory computer storage medium of claim 11, wherein the operations further comprise:
receiving refinement information, wherein the refinement information includes specific identifiers of particular products, wherein the property improvement projects are determined using estimated characteristics of the particular products; and
modifying the cost savings associated with one or more property improvement projects based on actual characteristics of the particular products.

13. The non-transitory computer storage medium of claim 9, wherein obtaining information describing a property comprises receiving, from a contractor, a specific address of a property owner, and wherein the one or more property improvement projects are a property improvement project to be implemented by the contractor, and wherein providing the property improvement project for presentation comprises:
providing costs, received from the contractor, associated with implementing the property improvement project, and providing utility cost savings after the property improvement project is implemented.

14. The non-transitory computer storage medium of claim 9, wherein obtaining information describing a property comprises:
receiving a particular address associated with the property, wherein information describing the property includes characteristics of the property, or
receiving an identification of the area, and determining a representative property associated with average characteristics of properties in the area, wherein information describing the representative property includes the average characteristics.

15. The non-transitory computer storage medium of claim 9, wherein providing property improvement projects comprises:
accessing one or more databases storing information associated with products; and
providing, for each property improvement project using the stored information, information identifying utility cost savings and costs to implement the project with different price tiers of products associated with the property improvement project, each price tier associated with a respective utility cost savings.

16. A system comprising one or more computer systems and one or more computer storage media storing instructions that when executed by the one or more computer systems, cause the one or more computer systems to perform operations comprising:
obtaining information describing property associated with a geographical area;
determining, using the information describing the property, one or more utility use estimates for products associated with a plurality of property improvement projects as applied to the property;
determining one or more property improvement projects to provide for presentation, from the plurality of property improvement projects, based on the utility use estimates; and
providing the one or more property improvement projects for presentation.

17. The system of claim 16, wherein providing property improvement projects includes providing a cost savings for each property improvement project over a selectable or preselected period of time.

18. The non-transitory computer storage medium of claim 17, wherein the operations further comprise:
receiving refinement information, wherein the refinement information includes specific identifiers of particular products, wherein the property improvement projects are determined using estimated characteristics of the particular products; and
modifying the cost savings associated with one or more property improvement projects based on actual characteristics of the particular products.

19. The system of claim 16, wherein obtaining information describing a property comprises receiving, from a contractor, a specific address of a property owner, and wherein the one or more property improvement projects are a property improvement project to be implemented by the contractor, and wherein providing the property improvement project for presentation comprises:
providing costs, received from the contractor, associated with implementing the property improvement project, and providing utility cost savings after the property improvement project is implemented.

20. The system of claim 16, wherein obtaining information describing a property comprises:
receiving a particular address associated with the property, wherein information describing the property includes characteristics of the property, or
receiving an identification of the area, and determining a representative property associated with average characteristics of properties in the area, wherein information describing the representative property includes the average characteristics.
